(19) United States
(12) Patent Application Publication
(10) Pub. No.: US 2026/0247141 A1
(43) Pub. Date: Aug. 20, 2026

(54) COLLUSION-RESISTANT BROADCAST ENCRYPTION WITH STATEFUL RECEIVERS

(71) Applicant: NTT Research, Inc., Sunnyvale, CA (US)

(72) Inventor: Mark Zhandry, San Francisco, CA (US)

(73) Assignee: NTT Research, Inc., Sunnyvale, CA (US)

(21) Appl. No.: 19/179,967

(22) Filed: Apr. 15, 2025

Related U.S. Application Data
(60) Provisional application No. 63/634,448, filed on Apr. 15, 2024.

(51) Int. Cl. H04W 12/033; H04L 9/32; H04W 12/106

(52) U.S. Cl. CPC H04W 12/033; H04L 9/3242; H04W 12/106

(57) ABSTRACT

The present disclosure provides a system for monitoring and controlling a vehicle. The system includes a vehicle having a plurality of sensors configured to collect data related to the vehicle's operation and environment. A control unit is communicatively coupled to the sensors and is configured to process the collected data. The system further includes a remote server communicatively coupled to the control unit via a wireless network. The remote server is configured to receive the processed data from the control unit, analyze the received data, and generate control instructions based on the analysis. The control unit is further configured to receive the control instructions from the remote server and implement the control instructions to adjust one or more operational parameters of the vehicle. The system also includes a user interface device communicatively coupled to the control unit and configured to display vehicle information and receive user inputs for controlling the vehicle.

### CROSS-REFERENCE TO RELATED APPLICATION

This application claims the benefit of U.S. Provisional Application Ser. No. 63/634,448 filed Apr. 15, 2024, the content of which is incorporated by reference herein in its entirety.

### FIELD OF THE INVENTION

The invention generally relates to broadcast encryption, and in particular broadcast encryption to stateful receivers with dynamic long-term keys.

### BACKGROUND OF THE INVENTION

Broadcast encryption (BE) aims to enable sending messages securely to a dynamic group of authorized users using as little communication and storage as possible. For a system with N total users, it is always trivial to have a transmission of size N×λ by simply encrypting separately to each authorized user. The goal then is to devise a system involving a single broadcast using much smaller communication, preferably while also minimizing storage.

The term “broadcast encryption” has mostly been used to refer to the setting where receivers are stateless, and cannot update their keys after joining the system. Stateless literature has focused on using advanced cryptographic tools such as pairings, lattices, obfuscation, multilinear maps, or some combination thereof to achieve short parameters. Many additional features have also been added to (stateless) BE, such as tracing, recipient privacy, polynomial-length identities, and adaptive security.

Meanwhile, the stateful setting has generally been referred to as multicast encryption, where receiver keys are updated via succinct update messages as users join and leave the system. Surprisingly, despite being conceptually close notions, the stateful and stateless literature are largely disjoint. Unlike stateless BE, the stateful setting has largely been studied using combinatorial techniques applied to standard cryptographic tools such as CPA-secure encryption, and has long had constructions with asymptotically optimal communication using these techniques. Moreover, features such as tracing, recipient privacy, polynomial-length identities, etc. that have been studied in the stateless setting have not been realized in the stateful setting. Going forward, we will refer to both as “broadcast encryption”.

While stateless receivers are naturally preferable as they simplify key management, stateful receivers come with two major advantages: communication costs, and forward secrecy.

Communication costs of stateless BE. A broadcast to general subsets of stateless receivers inherently requires N+λ bit ciphertexts. (For concrete A-bit security. For asymptotic security defined by polynomial time and negligible advantage, the lower bound would be N+ω(log λ).) This is because the ciphertext must encode the recipient set, which for general sets takes at least N bits to represent. In the literature, this lower bound usually manifests by explicitly listing the authorized recipient set S in each ciphertext; the performance of such systems is then characterized by how much additional ciphertext material is needed, with optimal schemes achieving poly(λ) overhead, independent of N. While the stateless receiver literature typically only talks about the additional overhead, the actual communication requires sending S as well. In this work we, we therefore consider the entire ciphertext size including both S and the overhead to accurately compare communication costs. Stateless receiver BE therefore requires sending N+λ bits for every ciphertext. In addition to quite large ciphertexts, the running time of encryption and decryption for stateless schemes is also typically Ω(N).

Meanwhile, no ciphertext-size lower bound applies to stateful setting (an overall communication lower-bound is also applicable to the stateless setting, except that it applies to the combined size of ciphertexts and all of the key updates needed to add the various users. Since adding/removing O(N) users involves O(N) key updates, this means the update to add/remove a single user and the ciphertext size can each simultaneously have size poly(λ), despite the lower-bound), and indeed old solutions achieve total ciphertext size (as well as update size and receiver storage requirements) that are all essentially independent of N, all while using standard tools.

Remark 1. One way to reduce communication in a stateless scheme is to have each user locally store the authorized user set S, and only update this set as users join and leave. Since the users all have local copies of S, now only the additional ciphertext overhead needs to be sent in each broadcast, which in an optimal scheme is poly(λ) bits. This approach comes with two drawbacks, however. First, since receivers need to store the dynamic set S, they are no longer stateless, which seems to defeat the purpose of a stateless scheme. Second, in general S will require N bits to store, resulting in modestly large receiver storage. The resulting scheme is therefore worse than stateful schemes in terms of parameter sizes, despite the fact that much stronger tools are needed. This approach also makes features like recipient privacy inherently impossible.

Forward secrecy. Another significant advantage of stateful receivers is that they are necessary if one wants forward secrecy; that is, if user i's key is leaked, then past encryptions for which i was authorized to decrypt remain secure. Forward secrecy has long been an important consideration in various cryptographic protocols such as key agreement, public key encryption, and signatures. Some stateful broadcast schemes, under the name “multicast encryption”, or under the name “broadcast encryption”, have proven forward secrecy. Stateless schemes, however, cannot offer such a guarantee, since a user's key can always decrypt all past and future communication intended for that user.

While stateful BE offers a major benefit in terms of communication cost and forward secrecy, we observe a number of limitations with existing solutions relative to their stateless counterparts:
(1) Tracing. If a user leaks their key or more generally a pirate decoder program built from their key, we would like to identify that user in order to revoke them. This is the goal of traitor tracing (Benny Chor and Amos Fiat and Moni Naor, Tracing Traitors (ChoFiaNao94)). While there are many solutions to tracing broadcast encryption systems in the stateless receiver setting, as discussed above these all require ciphertext size at least N+poly(λ), and no existing (stateful) solution achieving sub-linear total ciphertext size is traceble. (This is because existing stateful sublinear solutions ultimately encrypt the broadcast under a dynamic “group key” that is known to all authorized users. Any authorized user can leak just the group key, which will enable decrypting broadcasts until the next key update. As this group key is not specific to any user, it cannot be traced.)
(2) Recipient Privacy. We would like to hide the identities authorized users in order to protect their privacy. The stateless receiver literature has also considered “recipient private” BE which hides S. In particular Dan Boneh and Mark Zhandry, Multiparty Key Exchange, Efficient Traitor Tracing, and More from Indistinguishability Obfuscation (BonZha14) provide a solution with optimal N+poly(λ) ciphertext size, though the public key size is poly(N). No existing (stateful) construction with sub-linear ciphertext size has recipient privacy.
(3) Adaptive Security. Adaptive security is an important consideration in cryptography generally. Starting with Craig Gentry and Brent Waters, Adaptive Security in Broadcast Encryption Systems (with Short Ciphertexts) (GenWat09), many stateless broadcast systems achieve adaptive security with only a polynomial loss in the security reduction. However, the best (stateful) solutions with sub-linear total ciphertext size such as Saurabh Panjwani, Tackling Adaptive Corruptions in Multicast Encryption Protocols (Panjwani07); Karen Klein and Guillermo Pascual-Perez and Michael Walter and Chethan Kamath and Margarita Capretto and Miguel Cueto and Ilia Markov and Michelle Yeo and Joël Alwen and Krzysztof Pietrzak, Keep the Dirt: Tainted TreeKEM, Adaptively and Actively Secure Continuous Group Key Agreement (KPWKCCMYAP21) all have a quasi-polynomial loss.
(4) Compact Manager Storage. The group manager in stateless broadcast encryption solutions simply needs to know the current set of authorized users, which takes N bits. In contrast, stateful solutions typically are required to store cryptographic keys for each user, resulting in storage at least N×λ bits. Ran Canetti and Tal Malkin and Kobbi Nissim, Efficient Communication-Storage Tradeoffs for Multicast Encryption (CanMalNis99) use a clever solution that only requires space N×λ/log(N), which is still much larger than N.
(5) Identity-based. Some stateless BE schemes such as Cécile Delerablée, Identity-Based Broadcast Encryption with Constant Size Ciphertexts and Private Keys (Delerablee07) support user identities rather than indexes, where a user's identity (for the purposes of describing the recipient set and potentially also for tracing) is a polynomial-length string rather than an index in [N]. The combinatorial techniques in existing stateful broadcast schemes do not support identities.
(6) Batch Updates. Sometimes, it is necessary to add or revoke many users at a time. In the worst case, the status of all users might need updating. By breaking an update that changes the status of N users into N individual updates, existing stateful constructions can update all users with N×poly(λ) communication. However, we could hope to batch the updates into a single update of size N+poly(λ), which is optimal via the stateless BE lower-bound.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Our Work. In this work, we bring advanced cryptographic tools to the study of broadcast encryption in the stateful receiver setting. Our main result is:

Theorem 1 (Informal). Assuming the existence of (polynomially secure) indistinguishability obfuscation (iO) and one-way functions, there exists a broadcast encryption scheme with stateful recievers and the following features:
(1) The scheme is fully collusion resistant.
(2) Ciphertext size, key update messages, receiver storage, public key, and group manager storage are all poly(λ), independent of the number of users. (In particular, the group manager does not even need to know the set of currently authorized users.)
(3) The running time needed to encrypt, decrypt, add, or remove a user is poly(λ), independent of the number of users.
(4) The scheme is traceable, even against arbitrary collusions.
(5) The scheme is recipient private.
(6) The scheme has forward secrecy.
(7) The scheme is identity-based.
(8) Updates can be batched optimally.

In the indexed-based case where the identity space is polynomial-sized (logarithmically many bits), Theorem 1 is a combination of theorems from Section 5. See Appendix 11 for our extension to the identity-based setting where the identity space has size 2λ. Indistinguishability obfuscation (iO) can be built from “well-founded” assumptions. Post-quantum candidate iO has also been proposed from lattice-like assumptions. Our construction serves as a proof of concept that applying advanced cryptographic tools to the setting of stateful receivers can give broadcast encryption with far better asymptotic performance than is possible in the stateless setting, while also enjoying a number of novel features that were not possible before. Herein, we also show that optimal batched updates imply an optimal stateless scheme (Theorem 8, and thus as an immediate corollary we also obtain novel feasibility results for the stateless setting as well:

Corollary 1. Assuming iO and one-way functions, there exists a broadcast encryption scheme with stateless receivers with the following features:
(1) The scheme is fully collusion resistant.
(2) The ciphertext size is an optimal N+poly(λ), while the secret keys and public keys have size poly(λ), which are all optimal.
(3) The scheme is adaptively secure.
(4) The scheme is recipient private.
(5) The scheme is identity-based.

The only prior stateless broadcast scheme with recipient privacy and ciphertexts smaller than N×λ is BonZha14, which had large public keys, was not identity-based, and was only proved to be selectively secure. (Even assuming sub-exponential hardness would not be sufficient to make BonZha14 adaptively secure. This is because complexity leveraging blows up the ciphertext size too much, making ciphertexts no longer compact.) The prior adaptively secure obfuscation-based scheme (Mark Zhandry, Adaptively Secure Broadcast Encryption with Small System Parameters (Zhandryl4b)) was not identity-based, not recipient private, and required iO plus assumptions stronger than one-way functions.

As a secondary contribution, we also explore the use of Somewhere Statistically Binding (SBB) hashes in iO-based proofs. We observe that many existing results that utilize SSB hashes can actually use a weaker object called a targeted SSB hash instead, which is very similar to a stripped down version of positional accumulators. In turn, we explain how to build targeted SSB hashes from iO and one-way functions. This is in contrast to ordinary SSB hashes, are only known from algebraic assumptions. In fact, ordinary SSB hashes imply collision resistance, which is likely unachievable with iO and one-way functions alone, so such algebraic assumptions seem necessary. As a consequence, we improve on the assumptions used in several prior works such as Zhandryl4b; Pavel Hubacek and Daniel Wichs, On the Communication Complexity of Secure Function Evaluation with Long Output (HubWic15).

Remark 2. While iO is already considered a very strong assumption and all known constructions of iO rely on strong tools that imply ordinary SSB hashing anyway, it is still interesting and useful to understand what is generically necessary to achieve various applications. After all, it is conceivable that the assumptions underlying iO could someday be improved, and theoretical evidence such as Gilad Asharov and Gil Segev, Limits on the Power of Indistinguishability Obfuscation and Functional Encryption (AshSeg15) allows for the possibility that iO can be based on tools that do not imply SSB hashing.

According to an aspect of the present disclosure, a stateful broadcast encryption key management method, system, and non-transitory computer-readable medium storing instructions are provided. The method, system, and instructions, when executed by one or more processors, cause the one or more processors to perform operations comprising:

Establishing a signature scheme with collision resistance properties. Initial keys are transmitted to broadcast users by generating verification keys vk₀ and vk₁ and corresponding signing keys sk₀ and sk₁ using a secure key generation algorithm. The verification keys vk₀ and vk₁ are combined into a public key pk using a deterministic combination function. The public key pk is broadcast to the broadcast users over a secure communication channel. For each broadcast user with identity id, the identity is combined into a string s_{id} using a predetermined formatting protocol. The string s_{id} is signed using either sk₀ or sk₁ to obtain a signature σ_{id}, wherein sk₀ is used for unauthorized users and sk₁ is used for authorized users. The string s_{id} and signature σ_{id} are combined into a user secret key usk_{id} using a secure key derivation function. The user secret key usk_{id} is transmitted to the broadcast user through an encrypted communication channel.

At the start of an epoch, lists L_{add} and Lᵣₑₘₒᵥₑ of user identities to be added to or removed from the authorized user set are received, wherein L_{add} contains identities of users who should be granted access to broadcast messages and Lᵣₑₘₒᵥₑ contains identities of users whose access should be revoked. New verification keys

$${vk}_{0}^{′} and {vk}_{1}^{′}$$

and signing keys

$${sk}_{0}^{′} and {sk}_{1}^{′}$$

generated using a cryptographically secure random number generator. The new verification keys

$${vk}_{0}^{′} and {vk}_{1}^{′}$$

are combined into a new public key pk′ using the deterministic combination function. The keys vk₀, vk₁,

$${sk}_{0}^{′} , {sk}_{1}^{′} ,$$

and L_{add}, and Lᵣₑₘₒᵥₑ are combined into a program P that computes a new user secret key

$${usk}_{id}^{′}$$

from usk_{id}, wherein P implements a stateful transformation that maintains forward secrecy. The program P is obfuscated to obtain an obfuscated code Q using techniques that preserve the functionality of P while hiding its implementation details. The public key pk is replaced with pk′ in a secure storage medium. The new public key pk′ and obfuscated code Q are broadcast to the broadcast users through a broadcast channel with error detection and correction capabilities. The integrity of the broadcast is verified using cryptographic hash functions to ensure the broadcast has not been tampered with during transmission.

According to other aspects of the present disclosure, the method, system, and instructions may include one or more of the following features. Updated keys may be generated by replacing pk with pk′ at each broadcast user, running Q on usk_{id} to get

$${usk}_{id}^{′}$$

at each broadcast user with id and usk_{id}, and replacing usk_{id} with

$${usk}_{id}^{′}$$

at each broadcast user with id.

A message may be encrypted by storing a plaintext message m at one of the broadcast users, extracting vk₁ from the public key pk, combining m and vk₁ into the code of a program E which takes as input a user secret key usk_{id} and performs specific operations, obfuscating the program code E to obtain obfuscated code F, and transmitting the obfuscated code F as the encrypted message to the other broadcast users.

The encrypted message may be decrypted by receiving the encrypted message at at least one of the broadcast users with user secret key usk_{id}, wherein the encrypted message comprises the obfuscated code F, and running the obfuscated code F on usk_{id} to obtain the message m.

The signature scheme may be a constrained signature scheme with specific properties, including a constrained key generation algorithm, signature verification properties, and computational indistinguishability between constrained and unconstrained verification keys.

A tracing routine may be executed, comprising receiving the public key pk, a pirate decoder D, and data about D, extracting vk₁ from pk, executing a loop for a determined number of times, and based on the observed outputs, accusing one or more of the broadcast users of leaking the pirate decoder D.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a network system for communication between multiple devices, according to aspects of the present disclosure.

FIG. 2 depicts a flow diagram of a secure broadcast messaging system, in accordance with example embodiments.

FIG. 3 shows a flowchart of a method for managing a secure broadcast encryption system, according to an embodiment.

FIG. 4 illustrates a sequence diagram of a secure broadcast encryption system, according to aspects of the present disclosure.

FIG. 5 depicts a sequence diagram showing interactions in a secure broadcast encryption system, in accordance with example embodiments.

FIG. 6 shows a sequence diagram of a secure message transmission and encryption protocol, according to an embodiment.

FIG. 7 illustrates a stateful broadcast encryption system, according to aspects of the present disclosure.

FIG. 8 depicts a message encryption and decryption system, in accordance with example embodiments.

FIG. 9 shows a client computing architecture comprising multiple subsystems, according to an embodiment.

FIG. 10 illustrates a server-client network architecture, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

### 1 Definition of Stateful Broadcast

Here, we define our notion of Broadcast Encryption in the general setting of stateful receivers. Such a scheme consists of the following PPT algorithms, along with a length function ( [symbol] _{id}= [symbol] _{id} (λ):
(1) (pk, gmsk)←lnit (1^{λ}) takes as input the security parameter λ and initializes the system by generating an initial public key pk and the group manager's secret key gmsk. pk is published, and gmsk is kept privately by the group manager.
(2) usk_{id}←KeyGen(gmsk, pk, id, z) takes as input the group manager secret key gmsk, the current public key pk, an identity id∈{0, 1 [symbol] , and a bit z indicating whether user id should be authorized (z=1) or not (z=0). KeyGen outputs a user secret key usk_{id} for id.
(3) (pk′, um)←UpAuth(pk, (id, z)) updates the authorization status of user id, with z=1 indicating to add id to the authorized user set, and z=0 indicating to remove id. It takes as input the current public key pk, identity id, and bit z, and creates a new public key pk′ as well update message um, which are broadcast to all users. pk′ then replaces pk. User id is now considered authorized (2=1) or unauthorized (z=0) to decrypt broadcasts relative to the public key pk′. Setting (i, z)=(⊥, ⊥) will not change the status of any user, making UpAuth serve as simply a mechanism to refresh the keys of all users.
   While UpAuth is a publicly computable operation, we will assume for the purposes of this work that UpAuth is performed by a trusted party who is relied on to manage the authorized user group, perhaps the group manager. By having UpAuth be public, we allow for separating this entity from the entity that sets up the system and generates users' secret keys.
(4)

$${usk}_{id}^{′} ← UpK ( um , id , {usk}_{id} )$$

updates user id's secret key upon receiving the update message um generated by UpAuth. It takes as input um and the user's old secret key usk_{id}, and produces a new user secret key

$${usk}_{id}^{′} .$$

User id then replaces usk_{id} with

$${usk}_{id}^{′} .$$

(5) Enc(pk, m) encrypts a message. It takes as input the current public key pk and a message m, and outputs a ciphertext c.
(6) Dec(id, usk_{id}, c) decrypts a ciphertext. It takes as input a user identity id, its secret keys usk_{id}, and a ciphertext c, and produces a message m′.

Parameter Sizes and Running Times. If [symbol] ₘ is polynomial, then the identity space is exponential. In this case, we say the scheme is identity-based. If [symbol] ₘ is logarithmic, then the identity space is polynomial. In this case, the scheme is not identity-based, and we call user identities “indexes.”

Since the number of users is not an input to any algorithm above, the above formalization means that all parameter sizes and running times are independent of the number of users. We call such a scheme optimal. We could alternatively have a maximal number of users N which is an input to Init, in which case we could allow certain parameter sizes and running times to grow polynomially in N. If a certain parameter size (say, ciphertext size) depends on N, we will explicitly mention this in our theorem statements; all un-mentioned sizes are assumed to be optimal. We note that we would always have N≤ [symbol] .

Correctness. Due to the stateful nature of our notion, defining correctness is somewhat cumbersome. We give the formal definition in Appendix 6, and here just state that the intuitive correctness requirement is that any encrypted message should be decrypted back to the original message if the keys have not been updated. We will always insist on BE schemes being correct, and take the term “broadcast encryption” to mean “correct broadcast encryption.”

History Independence. An optional requirement for a stateful broadcast scheme is what we call history independence. Informally, this asks that the two different ways of computing a secret key for user id (directly through KeyGen, or by running UpK on some previous user secret key), always output exactly the same usk_{id}. While optional, in this work we will always aim for history independence, as it makes our various definitions of security simpler. The formal definition of history independence is given in Appendix 6.

Indistinguishability Security. For message privacy, we define an indisitnguishability notion of security using the following experiment Exp^{IND} (λ, [symbol] ) between an adversary [symbol] and challenger:
(1) The challenger runs (pk, gmsk)←lnit (1^{λ}) and sends pk to [symbol] . The challenge also chooses a random bit b. The game will then be divided into epochs. The challenger initializes sets Corr₀, Corr₁={ }, which indicate the corrupted unauthorized and corrupted authorized users, respectively. The challenger also initializes a bit DidChal to 0, which indicates if a challenge query has happened in the current epoch. The challenger will maintain that DidChal=0 (no challenge query in current epoch) or Corr₁={ } (no corrupted authorized users) at all times.
(2) [symbol] can now make several kinds of queries, in any order:
   (a) Corrupt: A submits a pair (id, z)∈{0, 1 [symbol] ×{0, 1}. The challenger computes usk_{id}←KeyGen(gmsk, pk, id, z) and sends it to [symbol] . The challenger adds id to Corr_{z} (if id is already in the set, then the set does not change. Note that id may now be in both sets). If at this point DidChal=1 and Corr₁≠0, the challenger immediately aborts and the adversary loses.
   (b) Authorize: [symbol] submits a pair (id, z)∈{0, 1 [symbol] ×{0, 1})∪{(⊥, ⊥)}. In response, the current epoch ends. If id∈Corr_{z-1}, then remove id from Corr_{z-1} and add it to Corr_{z}. Note that id will now be in Corr_{z} if it was previously in either Corr_{z} or Corr_{z-1}. The challenger sets DidChal=0.
      The challenger then runs (pk′, um)←UpAuth (pk, (id, z)), and sends pk′, um to [symbol] . The challenger finally replaces pk with pk′. The new epoch now begins.
   (c) Challenge Ciphertext: [symbol] submits two messages

$${m}_{0}^{*} , {m}_{1}^{*}$$

of equal length. The challenger sets DidChal=1. If at this point Corr₁≠0, the challenger immediately aborts and the adversary loses.
   The challenger now runs

$${c}^{*} ← Enc ( pk , {m}_{b}^{*} )$$

where pk is the current value of the public key. It sends c* to [symbol] .
[symbol] can make any number of the above queries with any values in any order, though by a simple hybrid argument we can assume there is only a single challenge query.
(3) Finally [symbol] outputs a guess b′ for b. The adversary wins if b′=b. The output of the experiment is 1 if the adversary wins and 0 otherwise.

Definition 1. The advantage of [symbol] is defined as Pr[1←Exp^{IND} (λ, [symbol] )]−1/2. We say that a history independent broadcast encryption scheme is adaptively indistinguishability (AD-IND) secure if, for every PPT adversary [symbol] , there exists a negligible function negl( [symbol] ) such that, for all security parameters λ, Pr[1←Exp^{IND} (λ, [symbol] )]≤1/2+negl( [symbol] ).

Remark 3. The above game captures forward secrecy: if a user id becomes corrupted in some epoch, all communication from prior epochs will be secure. This is because the challenger only checks that for there to be no corrupted authorized users in the epochs containing a challenge query. After a key update, the challenger will allow any corruption, even to previously authorized users that may have been encrypted to.

Remark 4. For broadcast schemes that are not history independent, we would need to consider that there are two ways for an adversary to obtain a secret key for a user identity: one is directly through KeyGen, but the other would be through corrupting an existing user whose key has been updated through one or more applications of UpK. These two ways of obtaining the secret key would result in different secret keys, so we would need to additionally model the corruption of existing users. In history independent schemes, however, both paths result in the same secret key, so it suffices to only consider keys that come directly from KeyGen.

### 1.1 Variants and Additional Properties

We can consider numerous variations on the above formalization.

Private key encryption and/or updates. We can relax encryption and/or updates to only require the group manager secret key gmsk instead of the public key pk, resulting in a secret key scheme. We will not consider these variants in this work.

Batch updates. Batching updates means that several updates to the authorized user set can be batched together into a single update. This can of course be accomplished trivially by simply running UpAuth on the desired identities and then concatenating the resulting update messages. To add or remove r users results in communication r×poly(λ). We could instead hope to add (resp. remove) r users with an update message um of size r [symbol] _{id}+poly(λ), which is essentially optimal since at a minimum the r user identities would need to be sent. We say that such a system has optimal batch updates. We say that such a batch update is partitioned if um is divided into two parts: an explicit description of the set of users being added (resp. removed) plus a poly(λ) bit header component.

We will also consider the case of batch reset, where all users status's are set to unauthorized, except for a selected set S of authorized users. Here, it takes |S|× [symbol] _{id} bits to write down the identities in S, so we expect the update message to have size |S|× [symbol] _{id}+poly(λ). Note that if a scheme has optimal batch updates, it is enough to only consider a batch reset of constant size which sets all users to be un-authorized. By composing such an all-un-authorized reset with a batch update, we can set all but S authorized users to be unauthorized.

In the case where [symbol] _{id}=log₂ N is logarithmic (an index-based scheme) we always have an upper bound of N bits to write out S, which will be smaller than |S|× [symbol] _{id} for large sets S. So in the logarithmic case, we will typically consider optimal batch resets to have communication of size N+poly(λ).

It is straightforward to update the correctness and security experiments to allow for the batching of updates/resets.

Tracing. In Appendix 7, we explain how to define tracing by adapting definitions from the stateless receiver setting.

Recipient Privacy. A broadcast scheme is recipient private if no information about the recipient set for users that are uncorrupted is revealed to the adversary. More precisely, we consider the following recipient privacy experiment Exp^{RecPriv} (λ, [symbol] ) between an adversary [symbol] and challenger: the game is identical to Exp^{IND} (λ, [symbol] ), except that there is no challenge query, no bit DidChal, and no aborting if DidChal=1ΛCorr₁≠0. Additionally, The challenger chooses a random bit b, and the adversary can now make one or more Challenge Update queries, where [symbol] submits two pairs (id₀, z₀), (id₁, z₁)∈({0, 1 [symbol] ×{0, 1})∪{(⊥, ⊥)}. Such queries are answered as follows:
(1) For x∈{0,1}, the challenger lets

$${Corr}_{z}^{( x )}$$

denote what Corr_{z} would be if it made an update using (idₓ, zₓ).
(2) The challenger checks that

$${Corr}_{z}^{( 0 )} = {Corr}_{z}^{( 1 )}$$

for both z=0, 1; if not, the challenger immediately aborts and [symbol] loses.
(3) The challenger performs an update according to (id_{b}, z_{b}). That is, it runs (pk′, um)←UpAuth(pk, (id_{b}, z_{b})), and sends pk′, um to [symbol] . It replaces Corr_{z} with

$${Corr}_{z}^{( b )}$$

for z=0, 1. The new epoch begins.

[symbol] can make any number corruption, ordinary update or challenge update queries with any values, though by a simple hybrid argument we can assume only a single Challenge Update query (alternatively, we can not have ordinary update queries, and simulate them with multiple Challenge Update queries).

Finally [symbol] outputs a guess b′ for b. The adversary wins if b′=b. The output of the experiment is 1 if the adversary wins and 0 otherwise.

Definition 2. The advantage of [symbol] is defined as Pr[1←Exp^{RecPriv} (λ, [symbol] )]−1/2. We say that a broadcast encryption scheme is adaptively Recipient Private (AD-RecPriv) secure if the advantage of every PPT A is negligible in λ.

Remark 5. The above definition ensures that if a user is corrupted, it still maintains recipient privacy for communication from prior epochs. This is because the challenger does not look at previous values of Corr₀, Corr₁ when performing its checks on the adversary.

Remark 6. We note that we can consider a relaxation of Exp^{RecPriv} (λ, [symbol] ) where the (single) challenge query always sets (id₁, z₁)=(⊥, ⊥), and this definition will be equivalent to Definition 2. This is because we conclude the indistinguishability of (id₀, z₀) and (id₁, z₁) by showing that each are indistinguishable from (⊥, ⊥). The only thing that needs to be checked is that (id₀, z₀), (⊥, ⊥) is always a “valid” challenge (in the sense that the challenger will not abort) as long as (id₀, z₀), (id₁, z₁) is valid. To see this, we first observe that we can exclude the case (id₀, z₀)=(id₁, z₁) since then the view of [symbol] is independent of b. Once this case is excluded, it must be that

$${Corr}_{z}^{( 0 )} = {Corr}_{z}^{( 1 )} = {Corr}_{z} .$$

This is because the only way for, say,

$${Corr}_{z}^{( 0 )} \neq {Corr}_{z}$$

is for the symmetric difference between

$${Corr}_{z}^{( 0 )}$$

and Corr_{z} to be id₀. The same holds for

$${Corr}_{z}^{( 1 )}$$

and id₁, and since we must have

$${Corr}_{z}^{( 0 )} = {Corr}_{z}^{( 1 )} ,$$

this implies id₀=id₁ and z₀=z₁. But then (id₀, z₀)=(id₁, z₁), which we already excluded. Since (⊥, ⊥) does not change Corr₀, Corr₁, and since

$${Corr}_{z}^{( b )} = {Corr}_{z} ,$$

this means that (id₀, z₀), (⊥, ⊥) and (id₁, z₁), (⊥, ⊥) are both valid challenges.

Stateless BE. In Appendix 8, we explain how to view stateless BE as a special case of stateful BE with certain extra requirements imposed on the algorithms. We also explain that optimal batched updates in stateful BE can be used to realize an optimal stateless BE scheme.

### 2 Augmented Stateful Broadcast

Here, we introduce a notion of augmented stateful broadcast encryption, an analog of augmented (stateless) broadcast introduced in BonWat06. Augmented broadcast encryption is a useful abstraction, as it readily implies both adaptive indistinguishability security and traceability.

In an augmented stateful BE scheme, the algorithm Enc comes with an optional third argument T∈[0, [symbol] ], which is assumed to be set to [symbol] if not specified. For correctness, we ask that Dec(id, usk_{id}, Enc(pk, m, T))=m as long as id≤T. This can be formalized by adapting the correctness requirement in Definition 10. For security, we ask, informally, for the following:
(1) Message Hiding. Enc(pk, m₀, T=0) and Enc(pk,m₁,T=0) are computationally indistinguishable for any messages m₀, m₁ of the same size
(2) Index Hiding. If the adversary has no authorized corrupted users in the interval (T₀, T₁] in an epoch with public key pk, then Enc(pk, m, T₀) is computationally indistinguishable from Enc(pk, m, T₁).

The above two properties can be readily adapted into formal security definitions by adapting the experiment Exp^{IND} (λ, [symbol] ) in Definition 1. Note that we will allow in general T₀, T₁ to be chosen adaptively.

Definition 3. We say that Π is a secure Augmented BE if it satisfies message hiding and index hiding.

We now give the following lemma, which is an adaptation of an analogous lemma from the stateless setting BonWat06.

Lemma 1. Suppose Π is a secure Augmented BE. Then it is AD-IND secure.

Proof. In the AD-IND security game, let

$${m}_{0}^{*} , {m}_{1}^{*}$$

be the challenge query. During this epoch, the adversary must have no authorized corrupted users. Thus by index hiding, we have that Enc(pk, m₀)=Enc(pk, m₀, [symbol] ) is indisitnguishable from Enc(pk, m₀, 0). By message hiding, Enc(pk, m₀, 0) in turn is indistinguishable from Enc(pk, m₁, 0). By invoking index hiding again, we have that Enc(pk, m₁, 0) is indistinguishable from Enc(pk, m₁, [symbol] )=Enc(pk, m₁).

### 3 Cryptographic Building Blocks

We discuss the cryptographic abstractions we will be using in this work. Note that all of the primitives below can be built from one-way functions and possibly indistinguishability obfuscation (iO). Therefore, our final construction can also be realized from iO and one-way functions.

Definition 4 (iO (Boaz Barak and Oded Goldreich and Russell Impagliazzo and Steven Rudich and Amit Sahai and Salil P. Vadhan and Ke Yang, On the (Im) possibility of Obfuscating Programs (BGIRSVY01))). An indistinguiability obfuscator iO is a PPT algorithm satisfying the following conditions:
(1) Functionality: For any circuit C, then with probability 1 over the choice of C″←iO(1^{λ}, C), C′(x)=C(x) for all inputs x.
(2) Security: For all pairs of PPT adversaries (S, D), if there is a negligible function α such that

$$Pr [ \vert {C}_{0} \vert = \vert {C}_{1} \vert ∧ {C}_{0} ( x ) = {C}_{1} ( x ) ∀ x : ( {C}_{0} , {C}_{1} , σ ) ← S ( λ ) ] > 1 - α ( λ )$$

then there exists a negligible function β such that

$$\vert Pr [ D ( σ , iO ( λ , {C}_{0} ) ) = 1 ] = Pr [ D ( σ , iO ( λ , {C}_{1} ) ) = 1 ] \vert < β ( λ )$$

Definition 5 (PRG). A pseudorandom generator (PRG) is a determinstic polynomial time algorithm G:{0, 1}^{λ}→{0, 1 [symbol] where [symbol] _{y} (λ) is a polynomial such that [symbol] _{y} (λ≥λ+1. We require that G(s) for s←{0, 1^{λ}} is computationally indistinguishable from y→{0, 1 [symbol] .

Note that by standard arguments, we can assume that G has any desired output length [symbol] _{y}.

Definition 6 (Puncturable PRF (Dan Boneh and Brent Waters, Constrained Pseudorandom Functions and Their Applications (BonWat13); Aggelos Kiayias and Stavros Papadopoulos and Nikos Triandopoulos and Thomas Zacharias, Delegatable pseudorandom functions and applications (KPTZ13); Elette Boyle and Shafi Goldwasser and Ioana Ivan, Functional Signatures and Pseudorandom Functions (BoyGolIva14))). A secure puncturable PRF (PRF) with domain is a pair of PPT algorithms (F, Punc) together with polynomials [symbol] ₓ= [symbol] ₓ(λ), [symbol] _{y}= [symbol] _{y} (λ) where:
(1) F(k, x) is deterministic and maps {0, 1}^{λ}×{0, 1 [symbol] to {0, 1 [symbol] .
(2) Punc(l, x) is potentially randomized, and takes as input a key k and an input x∈{0, 1 [symbol] , and outputs a “punctured” k k^{x̅}. We will overload notation, and also let F(k^{x̅}, y) denote the punctured evaluation function which takes as input the punctured key k^{x̅} and input y.
(3) Correctness: Except with negligible probability over the choice of k←{0, 1}^{λ},

$$F ( {k}^{\overline{x}} ( y ) = \{ \begin{matrix}F ( y ) & if y \neq x \\ ⊥ & if y = x\end{matrix}$$

(4) Security: For all x∈{0, 1 [symbol] , (k^{x̅}, F(k, x)) is computationally indistinguishable from (k^{x̅}, y), where k←{0, 1}^{λ} and y←{0, 1 [symbol] .

Definition 7 (SPB Hash (Jiaxin Guan and Daniel Wichs and Mark Zhandry, Incompressible Cryptography (GuaWicZha22))). A secure single-point binding (SPB) hash is a pair of PPT algorithms Π=(Gen, H) and polynomials [symbol] ₓ, [symbol] ₕ, [symbol] ₕₖ where:
(1) hk←Gen(1^{λ}, x*) takes as input the security parameter λ and input x*∈{0, 1 [symbol] , and outputs a hash key hk∈{0, 1 [symbol] .
(2) h←H(hk, x) is deterministic with inputs hk∈{0, 1 [symbol] and x∈{0, 1 [symbol] and output h∈{0, 1 [symbol] .
(3) Compression: There is a constant C<1 such that [symbol] ₕ(λ)≥C· [symbol] ₓ(λ).
(4) SPB: We say that hk is binding to x* if there does not exist any x ∈ {0, 1 [symbol] such that (1) x≠x*, and (2) H(hk, x)=H(hk, x*). We require that there exists a negligible negl(λ) such that, for any integer λ and any x* ∈ {0, 1 [symbol] , Pr[hk is binding to x*]≥1−negl(λ).
(5) Security: For all PPT adversaries [symbol] , there exists a negligible negl, such that [symbol] wins the following game against a challenger with probability at most

$$\frac{1}{2} + neg \vert ( λ ) :$$

(a) [symbol] (1^{λ}) chooses input

$${x}_{0}^{*} , {x}_{1}^{*} ∈ {\{ 0 , 1 \}}^{{ℓ}_{x} ( λ )}$$

(b) The challenger samples a random b ∈ {0, 1} and hk←Gen(1^{λ}, x*), and gives hk to [symbol] .
(c) [symbol] makes a guess b′ for b, and wins if b′=b.

Definition 8 (Constrained Signature (BonZha14)). A secure constrained signature scheme for a circuit class [symbol] =( [symbol] _{λ})_{λ} is a quadruple of PPT algorithms (Gen, Sign, Ver, GenConstr) and polynomial [symbol] ₘ= [symbol] ₘ(λ) where Gen, Sign, Ver satisfy the usual syntactic and correctness properties of a signature scheme with message space {0, 1 [symbol] . Additionally, we have the following:
(1) (vk′, sk^{C})←GenConstr(sk, C) takes as input a secret key sk and a circuit C ∈ [symbol] _{λ}, and produces a verification new constrained secret key sk^{C} and verification key vk′.
(2) Constrained Signing. For any circuit C ∈ [symbol] ^{λ} and with overwhelming probability over (sk, vk)←Gen(1^{λ}) and (vk′, sk^{C})←GenConstr(sk, C), it holds that Sign(sk^{C}, m)=Sign(sk, m) for all m such that C(m)=1. For all other m, Sign(sk^{C}, m)=⊥.
(3) Binding: For any circuit C ∈ [symbol] _{λ} and with overwhelming probability over (sk, vk)←Gen(1^{λ}) and (vk′, sk^{C})←GenConstr(sk, C), it holds that for any m with C(m)=0, Ver(vk′, m, σ)=0 for all σ.
(4) Security: For any circuit C ∈ [symbol] _{λ}, the distributions (sk^{C}, vk) and (sk^{C}, vk′) are computationally indistinguishable, where (sk, vk)←Gen(1^{λ}) and then (vk′, sk^{C})←GenConstr(sk, C).

Observe that security implies that vk′ accepts signatures made by Sign(sk^{C}, m) on messages m such that C(m)=1.

BonZha14 explain how to realize constrained signatures for general circuits from noninteractive witness indistinguishable proofs, which in turn can be based on iO and one-way functions (Nir Bitansky and Omer Paneth, ZAPs and Non-Interactive Witness Indistinguishability from Indistinguishability Obfuscation (BitPan15)). GuaWicZha22 also give a simple direct construction for the case where C accepts only a single input (which they call Single Point Binding (SPB) signatures), from iO and one-way functions. Here, we describe a simple construction that accomplished the dual of SPB signatures, namely functions x̅ that accept all but a single message x. We call this variant “punctured signatures”. Such punctured signatures are implicit in much of the obfuscation literature following the punctured programming approach of Amit Sahai and Brent Waters, How to use indistinguishability obfuscation: deniable encryption, and more (SahWat14); we mainly use it here just as a convenient abstraction.

Construction 1 (Punctured Signature) Let [symbol] =( [symbol] _{λ})_{λ} be the desired message space. Let iO be a secure i [symbol] , Π_{PPRF}=(F, Punc) be a secure puncturable PRF with domain [symbol] , and G be a secure length-doubling PRG. Let Π_{PSig}=(Gen, Sign, Ver, GenConstr) be the following:
(1) Gen(1^{λ}): sample a key k ∈{0, 1}^{λ}. Let sk=k and vk=iO(1^{λ}, V[k]), where V[k] is the program given in Table 1.
(2) Sign(sk, m): parse sk as k, and output σₘ←F(k, m).
(3) Ver(vk, m, σ): parse pk as a program \hat{V}, and run y←\hat{V}(m). Accept if and only if y=G(σ).
(4) GenConstr(sk, x̅): parse sk as k ∈ {0, 1}^{λ} and let k^{x̅}←Punc(k, x). Choose a random y←{0, 1}^{2λ}. Let sk^{x̅}=k^{x̅} and vk′=iO(1^{λ}, V′[x, k^{x̅}, y]), where V′ is the program given in Table 2. Observe that sk^{x̅} allows for computing signatures on any message other than x.

TABLE 1
The program V[k]

Inputs: m ∈ [symbol] _{λ}
Constants: k
(1) σₘ ← F(k, m)
(2) Output G(σₘ)

TABLE 2
The program V′[x, k^{x̅}, y]

Inputs: m ∈ [symbol] _{λ}
Constants: x, k^{x̅}, y
(1) If m = x, abort; output y
(2) σₘ ← F(k^{x̅}, m)
(3) Output G(σₘ)

Theorem 2. If iO, Π_{PPRF}, G are secure, then Π_{PSig} in Construction 1 is a secure punctured signature.

Remark 7. Observe that Construction 1 has deterministic signing. We can also obtain deterministic signing without loss of generality by de-randomizing using a PRF in the standard way.

### 4 Targeted SSB Hashing

Somewhere statistically binding (SSB) hashes were originally defined by HubWic15. Here, we define a relaxation which we will ultimately use in Section 5. Our relaxation will only make use of iO and one-way functions, instead of requiring additional algebraic assumptions as needed for ordinary SSB hashes. We expect this relaxation to have applications to removing such an additional assumption from various uses of SSB hashing in the context of iO. We discuss a few examples in Section 4.2 below. We now give our notion.

Definition 9. A secure targeted somewhere statistically binding (tSSB) hash consists of PPT algorithms Π=(Gen, H, Open, Ver) and a polynomials [symbol] _{Σ}, [symbol] ₕ, [symbol] ₕₖ, [symbol] _{π}, denoting the output, hash key, and proof lengths, respectively, such that:
(1) hk←Gen(1^{λ}, L, x*, i) takes as input the security parameter λ, an input-length L≤2^{λ}, a string x* ∈ Σ^{L}, and an index i ε [L], and outputs a hash key hk ε {0, 1 [symbol] . Here, Σ={0, 1 [symbol] .
(2) h←H(hk, x) is a deterministic polynomial time algorithm with inputs hk ∈ {0, 1 [symbol] and x ∈ Σ^{L} and output h ∈ {0, 1}^{L}^{ₕ}.
(3) π←Open(hk, x, j) takes inputs hk ∈ {0, 1 [symbol] , x ∈ Σ^{L}, and j ∈ L and produces a proof π∈ {0, 1 [symbol] .
(4) 0/1←Ver(hk, h, j, y, π) takes inputs hk ∈ {0, 1 [symbol] , h ∈ {0, 1 [symbol] , j ∈ [L], b ∈ Σ, π ∈ {0, 1 [symbol] , and outputs a bit indicating accept (1) or reject (0).
(5) Correctness: Ver accepts honest proofs for y=xⱼ. In other words, for any polynomial L=L(λ), there exists a negligible negl(λ) such that, for any integer λ, any x*, x ∈ Σ^{L}, any i, j ∈ [L], we have

$$Pr [ Ver ( nk , h , j , {x}_{j} , π ) = 1 : \begin{matrix}hk ← Gen ( {1}^{λ} , L , {x}^{*} , i ) \\ h ← H ( hk , x ) \\ π ← Open ( hk , x , j )\end{matrix} ] = 1 - negl ( λ )$$

(6) Targeted SSB: We say that hk is binding to x* at i if there does not exist an x ∈ Σ^{L}, π ∈ {0, 1 [symbol] such that (1) H(hk, x)=H (hk, x*), (2) xᵢ≠x*ᵢ, and (3) Ver(pk, H(hk, x*), i, xᵢ, π)=1. We require that, for any polynomial L=L(λ), there exists a negligible negl(λ) such that, for any integer λ, any x* ∈ Σ^{L} and any i ∈ [L], Pr[hk is binding to x* at i]≥1−negl(λ).
(7) Security: For all PPT adversaries [symbol] , there exists a negligible negl, such that [symbol] wins the following game against a challenger with probability at most

$$\frac{1}{2} + neg \vert ( λ ) :$$

(a) [symbol] (1^{λ}) chooses an integer L, an input x* ∈ Σ^{L}, and two indices i₀, i₁ ∈ [L].
(b) The challenger samples a random b ∈ {0, 1} and hk←Gen(1^{λ}, L, x*, i_{b}), and gives hk to [symbol] .
(c) [symbol] makes a guess b′ for b, and wins if b′=b.

Note that a plain SSB hash does not include x* as input to Gen, and strengthens the targeted SSB property so that hk is binding at i for all x*.

Remark 8. Definition 9 requires that the hash key hk has size bounded by a polynomial in λ that is independent of L. Most of the existing literature on SSB hashes does not explicitly include such a bound in their definitions. However, such a bound in necessary for all existing applications of SSB hashes, which inherently rely on a succinct hashing key. Technically, the existing definitions can imply such a bound on hk as a consequence of feeding L in binary to a polynomial-time Gen: Gen is a fixed polynomial in its input size, which for SSB hashes includes 1^{λ} and L (x* is not included in Gen for SSB hashes). Since the size of the binary representation of L is at most λ, the running time of Gen, and hence it's output length, can be bounded by a fixed polynomial in λ, regardless of L. We believe, however, that it is much more clear (and notationally consistent with the bounds on the size of h and π that are modeled in the prior literature) to include an explicit upper bound on the length of hk.

Remark 9. We can also extend the definition to handle multiple binding points i₁, i₁, . . . , iₙ, where n is a priori bounded. It is easy to construct a tSSB hash accommodating n binding points from one accommodating only 1: simply sample n independent hashing keys hk₁, . . . , hkₙ, and the output of the hash on x is the concatenation of each of the H(hkᵢ, x). To bind at positions i₁, . . . , iₙ, simply bind each hkⱼ to iⱼ. As long as n is small (e.g. a fixed polynomial in λ) the asymptotics of the tSBB hash will be preserved.

Remark 10. We can also extend the definition so that the bit-length [symbol] _{Σ} of Σ is given as input to Gen. Most constructions of SSB hashing (and our construction of tSSB hashing from iO and one-way functions) naturally extend to such larger alphabets. We can also generically extend to larger alphabets by dividing the input into blocks of u terms, and letting our new alphabet be an entire block. Then if we have scheme that supports binding at u positions (per Remark 9), we can bind to an entire block by binding to each of the u positions in that block.

4.1 Construction from SPB Hashing

We now show how to construct a secure tSSB hash from single-point binding (SPB) hashing (Definition 7), which in turn can be built from iO and one-way functions. We discuss other ways to instantiate SPB hashes in Section 9.

Construction 2 Let Π_{SPB}=(Gen_{SPB}, H_{SPB}) be an SPB hash with [symbol] ₓ, [symbol] ₕ the input and output length polynomials. Assume for simplicity that the compression constant is C=1/2 so that [symbol] ₓ=2 [symbol] ₕ, though the protocol can be adapted to any C<1. We will let Σ={0, 1 [symbol] . Let Π_{tSSB}=(Gen_{tSSB}, H_{tSSB}, Open, Ver) be the following:
(1) Gen_{tSSB} (1^{λ}), L, x*, i): Let B be the smallest integer such that L≤2^{B}. Consider the complete binary tree T with 2^{B} leaves. We assign to each node of the tree a value in Σ, proceeding layer by layer from the leaves to the root as follows:
   (a) For the first L leaves, place

$${x}_{j}^{*}$$

into the jth. Place [symbol] in the remaining leaves.
(b) For k=B, . . . , 1, do the following: let iₖ denote the integer consisting of the first k−1 bits of i. Let u* be the node at depth k−1 in position iₖ, and v*, w* its children, containing values:

$${x}_{{v}^{*}}^{*} , {x}_{{w}^{*}}^{*} .$$

Sample

$${hk}_{k} ← {Gen}_{SPB} ( {1}^{λ} , {x}_{{v}^{*}}^{*} ‖ {x}_{{w}^{*}}^{*} ) .$$

Now for each node u at depth k−1, with children v, w containing values

$${x}_{v}^{*} , {x}_{w}^{*} ,$$

place the value

$${x}_{u}^{*} ← {H}_{SPB} ( {hk}_{k} , {x}_{v}^{*} ‖ {x}_{w}^{*} )$$

into node u.
Output hk=(hk₁, . . . , hk_{B}).
(2) H_{tSSB} (hk, x): We fill in the nodes of tree T as follows:
   (a) For the first L leaves, place xⱼ into the jth leaf. Place [symbol] in the remaining leaves.
   (b) For each internal node u at depth k−1, with children v, w containing values xᵥ, x_{w}, place the value xᵤ←H_{SPB} (hkₖ, xᵥ∥x_{w}) into node u.
   Let r be the root, and xᵣ the value contained in the root. Output xᵣ.
(3) Open (hk, x, j): Fill in the tree T as in H_{tSSB} (hk, x). Let S contain all the nodes on the path from the root to the jth leaf, plus each of their siblings. Output π=(xᵤ)_{u∈S}.
(4) Ver(hk, h, j, b, π): Parse π as (xᵤ)_{u∈S} where S is as above. Parse hk=(hk₁, . . . , hk_{B}). Let r be the root of T, and overload notation by letting j be the jth leaf node. Check the following: (1) h=xᵣ; (2) xⱼ=b; (3) xᵤ=H_{SPB} (hkₖ, xᵥ∥x_{w}) for each u on the path between r and j, where k−1 is the depth of u and v, w are the children of u. If all the checks pass, output 1; otherwise output 0.

Theorem 3. If Π_{SPB} is a secure SPB hash, then Π_{tSSB} is a secure tSSB hash.

This theorem is proved in Appendix 9. Guan, Wichs, and Zhandry (GuaWicZha22) construct SPB hashes from iO and any one-way function. Thus, we get an immediate corollary:

Corollary 2. Assuming iO and one-way functions exist, so do tSSB hashes.

As the main application of SSB hashes (and therefore also tSSB hashes) is in iO-based constructions, Corollary 2 shows that tSSB hashes will be “free” in almost all settings. This is in contrast to the case of SSB hashes, which implies collision resistance and therefore probably cannot be constructed from iO and one-way functions (AshSeg15). Worse, the only known constructions of ordinary SSB hashes require number-theoretic assumptions. In Appendix 9, we also explain how to construct SPB hashes from (singly) homomorphic encryption, giving yet another way to realize tSSB hashes that does not require iO.

4.2 Applications of tSSB Hashes

Roughly speaking, tSSB hashes can be used anywhere that an SSB hash is used, so long as in the security experiment the hash key is chosen after or independently from the input that we are trying to bind to. This includes the case where the input is chosen honestly. Applications of this form include many, but certainly not all, applications of SSB hashes. Sometimes, the protocol will need to be tweaked to use a tSSB hash. For example, the protocol may have included the hash key in the public key or CRS, and security allows the adversary to choose the input after seeing the public key/CRS. But in many cases, the hash key could have actually been chosen much later, and importantly after the adversary chooses their input. In these cases, a tSSB hash likely suffices.

### 5 Constructing Index-Based Broadcast Encryption

We give our basic construction of a stateful broadcast encryption scheme from iO and one-way functions, in the case of polynomial-sized identities (logarithmic bit-length), aka indexes. We start with a basic construction, which we will then extend in Section 11.4 to have batch updates.

Construction overview. Each epoch will be associated with two verification keys vk₀, vk₁ for a signature scheme. The secret keys for authorized users will be a signature of their identity relative to vk₁, and the secret keys for unauthorized users will be signatures relative to vk₀. To encrypt a message m to the authorized user set, we obfuscate the program which takes as input an index and signature, checks that the signature is valid relative to vk₁, and outputs m if so. Updating is done via another obfuscated program which takes as input an index and signature relative to vk₀ or vk₁, and if the signature is valid outputs a new signature relative to

$${vk}_{0}^{′} or {vk}_{1}^{′} ,$$

the keys for the next epoch. For users whose status is unchanged, the signature is produced relative to

$${vk}_{z}^{′}$$

where the input signature was valid for vk_{z}. For the user being added (resp. removed), the output signature is relative

$${vk}_{1}^{′}$$

(resp.

$${vk}_{0}^{′} )$$

regardless of which vk_{z} the input signature was valid for. Proving augmented BE (and hence adaptive security) requires a careful puncturing theorem that requires both iO plus the constrainability of the signature scheme.

Construction 3 Let Π_{PSig}=(Gen, Sign, Ver, GenConstr) be a punctured signature scheme, which we will assume to have deterministic signing. Let Πₚₖₑ=(Genₚₖₑ, Encₚₖₑ, Decₚₖₑ) be a public key encryption scheme. Let [symbol] _{id} be any desired identity length and N= [symbol] ; we will interpret the identity space {0, 1 [symbol] as the set of integers [N] in an arbitrary way. Define Π_{BE}=(Init, UpAuth, UpK, Enc, Dec):
(1) Init(1^{λ}): Run (sk₀, vk₀), (sk₁, vk₁)←Gen(1^{λ}) and (ek, dk)←Genₚₖₑ (1^{λ}). Run g←Encₚₖₑ (ek, (sk₀, sk₁)). Set gmsk=dk and pk=(vk₀, vk₁, ek, g).
(2) KeyGen(gmsk, pk, id, z): Parse pk as (vk₀, vk₁, ek, g) and gmsk as dk, and run (sk₀, sk₁)←Decₚₖₑ (dk, g). Output usk_{id}←Sign(sk_{z}, id).
(3) UpAuth(pk, (id, z)): parse pk as (vk₀, vk₁, ek, g). Run

$$( {sk}_{0}^{′} , {vk}_{0}^{′} ) , ( {sk}_{1}^{′} , {vk}_{1}^{′} ) ← ( Gen ( {1}^{λ} ) .$$

Let

$${g}^{′} ← {Enc}_{pke} ( ek , ( {sk}_{0}^{′} , {sk}_{1}^{′} ) ) .$$

Let

$$\hat{U} ← iO ( {1}^{λ} , U [ {vk}_{0} , {vk}_{1} , {sk}_{0}^{′} , {sk}_{1}^{′} , id , z ] )$$

where U is the program in Table 3. Output

$${pk}^{′} = ( {vk}_{0}^{′} , {vk}_{1}^{′} , ek , {g}^{′} )$$

and um=Û.
(4) UpK(um, id, usk_{id}): Parse um as Û and usk_{id} as σ_{id}. Run

$${σ}_{i}^{′} ← \hat{U} ( id , {σ}_{id} ) .$$

Output

$${usk}_{id}^{′} = {σ}_{id}^{′} .$$

(5) Enc(pk, m): Parse pk as (vk₀, vk₁, ek, g). Output Ê←iO(1^{λ}), E[vk₁, m, N]), where E is the program in Table 4.
(6) Dec(id, usk_{id}, Ê): Parse usk_{id}=σ_{id}. Output the decrypted message m′←Ê(id, σ_{id}).

TABLE 3
$U [ {vk}_{0} , {vk}_{1} , {sk}_{0}^{′} , {sk}_{1}^{′} , id , z ]$

| Inputs: u, σ | |
|---|---|
| $Constants \text{:} {vk}_{0} , {vk}_{1} , {sk}_{0}^{′} , {sk}_{1}^{′} , id , z$ | |
| (1) If Ver(vk₀, u, σ) = 0 ∧ Ver(vk₁, u, σ) = 0: | |
| | abort; output ⊥ |

$( 2 ) b ← \{ \begin{matrix}0 & if u \neq id ⋀ Ver ( {vk}_{0} , u , σ ) = 1 \\ 1 & if u \neq id ⋀ Ver ( {vk}_{1} , u , σ ) = 1 \\ z & if u = id\end{matrix}$
$( 3 ) Output Sign ( {sk}_{b}^{′} , u )$

TABLE 4
E[vk, m, j]

Inputs: u, σ
Constants: vk, m
(1) If u > j: abort; output ⊥
(2) If Ver(vk, u, σ) = 0:

abort; output ⊥

(3) Output m

The correctness of our protocol follows readily from the correctness of the underlying building blocks. To see this, observe that usk_{id} is always a signature relative to vk_{z} on the integer id, where z is the bit indicating whether or not id is in the authorized user set. Assuming that Π_{PSig} has deterministic signing, it is also clear that the protocol is history independent. We now prove security.

### 5.1 Puncturing Theorem

In order to prove security, we will first introduce some technical results which says that, in the security experiment, if an adversary guarantees to not have an authorized (resp. unauthorized) corrupted key for some identity id* in a particular epoch, then we can puncture the verification key corresponding to authorized (resp. unauthorized) keys for that epoch at the identity id*, and the adversary cannot tell the difference. With the punctured verification key, this means that there are simply no authorized (resp. unauthorized) keys for id* in that epoch. This will allow us, in our final security proof, to modify certain other programs in order to prove security.

For an epoch t in the security experiment, let id^{t}, z^{t} be the value of the query that triggered the start of epoch t. Let

$${Corr}_{0}^{t} , {Corr}_{1}^{t}$$

be the values of the sets Corr₀, Corr₁ at the end of the epoch t. Let

$${pk}^{t} = ( {vk}_{0}^{t} , {vk}_{1}^{t} , ek , {g}^{t} )$$

be the value of pk during epoch t, and let um^{t} be the update message that was generated with pk^{t}. Let

$${sk}_{0}^{t} , {sk}_{1}^{t}$$

be the signing keys sampled along with

$${vk}_{0}^{t} , {vk}_{1}^{t} .$$

Consider an epoch t. We say that t is punctured at (id, z) if we make the following changes to the epoch:
(1)

$${pk}_{z}^{t}$$

(the zth component of p^{kt} using 0-indexing) has been set to

$${( {vk}^{′} )}_{z}^{t}$$

instead of

$${vk}_{z}^{t} ,$$

where

$$( {( {vk}^{′} )}_{z}^{t} , {( {sk}^{\overline{id}} )}_{z}^{t} ) ← GenConstr ( {sk}_{z}^{t} , \overline{id} ) .$$

(2) um^{t} is set to

$$iO ( {1}^{λ} , U [ {pk}_{0}^{t - 1} , {pk}_{1}^{t - 1} , {S}_{0} , {S}_{1} , {id}^{t} , {z}^{t} ] )$$

where S_{z} has been set to

$${( {sk}^{\overline{id}} )}_{z}^{t}$$

instead of

$${sk}_{z}^{t} ,$$

and S_{1-z} remains as

$${sk}_{1 - z}^{{t}^{*}} .$$

(3) g^{t} has been set to Encₚₖₑ (ek, (S₀, S₁)) where S₀, S₁ have been modified as above.
(4) The experiment will immediately abort and the adversary loses if ever

$$id ∈ {Corr}_{z}^{t} .$$

particular, the adversary loses if it ever makes a corruption query on (id, z) during epoch t.

Note that an epoch can also be punctured at both (id, 0) and (id, 1), in which case we change both

$${pk}_{0}^{t} , {pk}_{1}^{t}$$

and S₀, S₁. we will say that an epoch is unpunctured if pk^{t} and um^{t} are generated as in UpAuth(pk^{t-1}, (id^{t}, z^{t}))).

A local puncturing lemma. As a technical building block to our main security theorem for this section, we will make use of the following local puncturing lemma.

Lemma 2. Fix (t, id, z). Suppose the adversary guarantees that

$$id ∉ {Corr}_{z}^{t} .$$

Assume no epoch is punctured except at pairs of the form (id, z′). Additionally assume any of the following conditions are met:
(1) t=1
(2)

$$id ∉ {Corr}_{0}^{t - 1} ⋃ {Corr}_{1}^{t - 1}$$

and epoch t−1 is punctured at both (id, 0) and (id, 1).
(3)

$$id ∈ {Corr}_{1 - z}^{t - 1} \backslash {Corr}_{z}^{t - 1} , ( {id}^{t} , {z}^{t} ) \neq ( id , z )$$

and epoch t−1 is punctured at (id, z).
(4)

$$id ∈ {Corr}_{z}^{t - 1} and ( {id}^{t} , {z}^{t} ) = ( id , 1 - z ) .$$

Then if Πₚₖₑ is a secure public key encryption scheme, iO is a secure indistinguishability obfuscator and Π_{PSig} is a secure punctured signature scheme, for any PPT adversary [symbol] , we can switch epoch t to be punctured at (id, z), and this change is indistinguishable to [symbol] . Proof. We prove indistinguishability by a sequence of hybrids.

Hybrid H₀: Let H₀ be the experiment where t is not punctured at (id, z). Observe that in H₁, decrypting g^{t′} to answer corruption queries will give

$${sk}_{{z}^{′}}^{{t}^{′}} .$$

So it is equivalent to simply answer the queries directly by using

$${sk}_{{z}^{′}}^{{t}^{′}}$$

as opposed to decrypting g^{t′}. As such, the experiment can be simulated without needing dk.

Hybrid H₁: Let H₁ be the same as H₀, except that we set sample

$$( {( {vk}^{′} )}_{z}^{t} , {( {sk}^{\overline{id}} )}_{z}^{t} ) ← GenConstr ( {sk}_{z}^{t} , \overline{id} ) ,$$

and answer all corruption queries (id′, z), id′≠id, in epoch t with

$${( {sk}^{\overline{id}} )}_{z}^{t} .$$

### Since

$${( {sk}^{\overline{id}} )}_{z}^{t}$$

gives the same signatures as

$${sk}_{z}^{t} ,$$

this change is iundetectable.

Hybrid H₂: Now we change g^{t} to be Encₚₖₑ (ek, (S₀, S₁)) where S_{z} has been changed to

$${( {sk}^{\overline{id}} )}_{z}^{t} .$$

This change is undetectable by the security of Πₚₖₑ. Note that, at this point, it is equivalent to answer corruption queries by decrypting gt′ to recover the signing keys, as opposed to using the signing keys directly.

Hybrid H₃: Now if t>1 we change um^{t} to be

$$iO ( {1}^{λ} , U [ {pk}_{0}^{t - 1} , {pk}_{1}^{t - 1} , {S}_{0} , {S}_{1} , {id}^{t} , {z}^{t} ] )$$

where S_{z} has been changed as in H₂. If t=1, H₃ is the same as H₂. Indistinguishability from H₂ follows from iO security and the claim that

$$U [ {pk}_{0}^{t - 1} , {pk}_{1}^{t - 1} , {S}_{0} , {S}_{1} , {id}^{t} , {z}^{t} ]$$

is functionally equivalent to

$$U [ {pk}_{0}^{t - 1} , {pk}_{1}^{t - 1} , {sk}_{0}^{t} , {sk}_{1}^{t} , {id}^{t} , {z}^{t} ] .$$

We can see the equivalence by looking at the cases:
(1)

$$id ∉ {Corr}_{0}^{t - 1} ⋃ {Corr}_{1}^{t - 1}$$

and epoch t−1 is punctured at both (id, 0) and (id, 1). In this case, there is no valid signature on id relative to either

$${pk}_{0}^{t - 1} , {pk}_{1}^{t - 1} .$$

This means

$$U [ {pk}_{0}^{t - 1} , {pk}_{1}^{t - 1} , {sk}_{0}^{t} , {sk}_{1}^{t} , {id}^{t} , {z}^{t} ]$$

never needs to sign id using

$${sk}_{z}^{t} ( or {sk}_{1 - z}^{t} ) .$$

Thus, we can replace

$${sk}_{z}^{t}$$

with

$${( {sk}^{\overline{id}} )}_{z}^{t} )$$

without changing the program functionality.
(2)

$$id ∈ {Corr}_{1 - z}^{t - 1} \backslash {Corr}_{z}^{t - 1} , ( {id}^{t} , {z}^{t} ) \neq ( id , z )$$

and epoch t−1 is punctured at (id, z). Since (id^{t}, z^{t})≠(id, z), we know that U is not updating the authorization status of id to be z, meaning it only has to sign id using

$${sk}_{z}^{t}$$

if it received a valid signature on id relative to

$${pk}_{z}^{t - 1} .$$

But in this case there is no valid signature on id relative to either

$${pk}_{z}^{t - 1} ,$$

meaning U never needs to sign id using

$${sk}_{z}^{t} .$$

Thus, we can replace

$${sk}_{z}^{t}$$

with

$${( {sk}^{\underline{id}} )}_{z}^{t} )$$

without changing the program functionality.
(3)

$$id ∈ {Corr}_{z}^{t - 1} and ( {id}^{t} , {z}^{t} ) = ( id , 1 - z ) .$$

Here, the program U only ever outputs signatures on id relative to

$${sk}_{1 - z}^{t} ,$$

since the authorization status of id is changed to 1−z. This holds regardless of pk^{t-1}. Thus, we can replace

$${sk}_{z}^{t}$$

with

$${( {sk}^{\underline{id}} )}_{z}^{t} )$$

without changing the program functionality.

Hybrid H₄. This is the same as H₃, except that we change

$${pk}_{z}^{t}$$

to be

$$( {( {vk}^{′} )}_{z}^{t} .$$

Notice that the rest of the experiment is simulated using just

$${( {sk}^{\overline{id}} )}_{z}^{t} ) .$$

AS such, this change is undetectable by the punctured signature security of Π_{PSig}.

Now we observe that in Hybrid H₄, epoch t is fully punctured at (id, z). Moreover, we showed that H₄ is indistinguishable from H₀ by the triangle inequality. This therefore completes the proof of Lemma 2.

Our Puncturing Theorem. We are now ready to give our main puncturing theorem for the section.

Theorem 4. Consider a PPT adversary [symbol] which commits to an epoch t* and pair (id*, z*) at the beginning of the experiment. Then epoch t* is either punctured at (id*, z*) or left unpunctured. In both cases, the experiment will immediately abort and the adversary loses if

$${id}^{*} ∈ {Corr}_{{z}^{*}}^{{t}^{*}} .$$

If Πₚₖₑ is a secure public key encryption scheme, iO is a secure indistinguishability obfuscator and Π_{PSig} is a secure punctured signature scheme, then the punctured and unpunctured cases are computationally indistinguishable.

Proof. The abort condition then ensures that

$${id}^{*} ∉ {Corr}_{{z}^{*}}^{{t}^{*}} .$$

There are four possibilities:
(1)

$${id}^{*} ∉ {Corr}_{0}^{{t}^{*} - 1} ⋃ {Corr}_{1}^{{t}^{*} - 1} ;$$

or
(2)

$${id}^{*} ∈ {Corr}_{1 - {z}^{*}}^{{t}^{*} - 1} \backslash {Corr}_{{z}^{*}}^{{t}^{*} - 1} and ( {id}^{{t}^{*}} , {z}^{{t}^{*}} ) \neq ( {id}^{*} , {z}^{*} ) ;$$

or
(3)

$${id}^{*} ∈ {Corr}_{{z}^{*}}^{{t}^{*} - 1}$$

and (id_{t*}, z^{t*})=(id*, 1−z*); or,
(4) t*=1, the first epoch.

Note that the first case implies that id* has not been corrupted at all through epoch t*−1. On the other hand, by induction, if there exists some t such that

$${id}^{*} ∈ {Corr}_{0}^{{t}^{*}} ⋃ {Corr}_{1}^{{t}^{*}}$$

(that is, id* was corrupted at some point), then there must exist a t₀≤t* such that
(1) Either t₀=1 or both

$${id}^{*} ∈ {Corr}_{{z}^{*}}^{{t}_{0} - 1}$$

and (id^{t}^{₀}, z^{t}^{₀})=(id*, 1−z*).
(2) For each t ∈ (t₀, t*], (id^{t}, z^{t})≠(id*, z*)

Incurring only a polynomial loss in security, we can assume that [symbol] additionally commits at the beginning of the experiment to (1) whether or not it will corrupt id* prior to epoch t*, and (2) if it does corrupt id*, it commits to t₀.

In all cases, we will prove indistinguishability of the punctured and unpunctured cases by making use of the local puncturing lemma (Lemma 2).

No corruption of id*. Suppose id* is not corrupted prior to epoch t*. By applying the local puncturing lemma several times, we can therefore puncture each epochs 1 through t*−1 at both (id*, 0), (id*, 1), and then finally puncture epoch t* at (id*, z*). Next, we iteratively remove the punctures (id*, 0), (id*, 1) for epochs t*−1 through 1, again using the local puncturing lemma. The result is that only t* is punctured at (id*, z*), as desired.

id* corrupted. Suppose id* is corrupted at some point prior to t*. Let to be as above. Then by applying the local puncturing lemma several times, we can puncture epochs to through t* at (id*, z*). Then we iteratively remove the punctures for epochs t*−1 through to. The result is that only t* is punctured at (id*, z*), as desired.

Thus, in either case we can puncture epoch t* at (id*, z*), as desired.

### 5.2 Augmented Stateful BE

We explain that Construction 3 is actually an augmented BE scheme, by setting Enc(pk, m, T) to output Ê←iO(1^{λ}), E[vk₁, m, T]), where E is the program in Table 4. Correctness follows immediately from the description of E.

Theorem 5. If Πₚₖₑ is a secure public key encryption scheme, iO is a secure indistinguishability obfuscator and Π_{PSig} is a secure punctured signature scheme, then protocol Π_{BE} in Construction 3 is a secure augmented BE scheme.

As immediate corollaries, by applying Lemmas 1 and 3, we obtain that IBE is both AD-IND secure and traceable. We now give the proof of Theorem 5.

Proof. We prove message hiding and index hiding separately.

Message hiding. We observe that

$$E [ {pk}_{1}^{{t}^{*}} , m , 0 ]$$

rejects an inputs. Thus by iO, the obfuscations of

$$Enc ( pk , {m}_{0}^{*} , 0 ) and Enc ( pk , {m}_{1}^{*} , 1 )$$

are indistinguishable.

Index Hiding. Since the domain is polynomial, it suffices to only consider intervals (id*−1, id*] containing a single point, and extend to arbitrary intervals via a simple hybrid argument. We can also assume the adversary commits to id* at the beginning of the experiment with only a polynomial loss in security, since the identity-space is polynomial. We can also assume the challenge epoch t* is committed to at the beginning since there are only a polynomial number of epochs.

During the challenge epoch, the adversary guarantees that id* is not both authorized and corrupted. We now invoke our puncturing theorem (Theorem 4), which shows that we can switch to a hybrid where epoch t* has been punctured at (id, 1). This means there are no valid signatures for id* to be authorized. As such.

$$E [ {pk}_{1}^{{t}^{*}} , m , id ]$$

will reject all inputs whose identities are id*. This means that

$$E [ {pk}_{1}^{{t}^{*}} , m , id ] and E [ {pk}_{1}^{{t}^{*}} , m , id - 1 ]$$

are functionally equivalent, so by iO their obfuscations are indistinguishable.

### 5.3 Recipient Privacy

Theorem 6. If Πₚₖₑ, iO and Π_{PSig} are secure, then Construction 3 is adaptively recipient private.

Proof. We will use the variant of Experiment Exp^{RecPriv}(λ, [symbol] ) where there is only a single challenge authorization query. Per Remark 6, we will consider the case where the challenge query is (id*, z*), (⊥, ⊥). In order for the challenger in experiment Exp^{RecPriv} (λ, [symbol] ) to not abort, we must have that

$$id ∉ {Corr}_{1 - {z}^{*}}^{{t}^{*} - 1} ,$$

where t* is the epoch initiated by the challenge query. This is because an update on (id*, z*) cannot change the authorized and unauthorized corrupted user set between epochs t*−1 and t* (since (⊥, ⊥) does not).

We therefore invoke our puncturing theorem (Theorem 4), which shows we can switch to a hybrid where epoch t*−1 is punctured at (id*, 1−z*). The result is that any distinguisher must still distinguish an authorization update (id*, z*) from (⊥, ⊥) even with epoch t*−1 punctured.

Now that t*−1 is punctured at (id*, 1−z*), this means there are no valid signatures on id* relative to

$${pk}_{1 - {z}^{*}}^{{t}^{*} - 1} .$$

But this means that both

$$\\ U [ {pk}_{0}^{{t}^{*} - 1} , {pk}_{1}^{{t}^{*} - 1} , {sk}_{0}^{{t}^{*}} , {sk}_{1}^{{t}^{*}} , {id}^{*} , {z}^{*} ] and$$

$$\\ U [ {pk}_{0}^{{t}^{*} - 1} , {pk}_{1}^{{t}^{*} - 1} , {sk}_{0}^{{t}^{*}} , {sk}_{1}^{{t}^{*}} , ⊥ , ⊥ ]$$

reject all signatures on id* having authorization status 1−z*. But such signatures are the only places where the two programs could have differed, meaning they have the same functionality. Thus by iO security, their obfuscations are indistinguishable. This means they must also be indistinguishable in the unpunctured setting, thereby proving Theorem 6.

### 5.4 Batching Updates

Here, we explain how to batch updates. We will consider two cases, one where we want a partitioned batch update, and another where we want a recipient private batch update. The high-level blueprint is to output an obfuscated program \hat{B} which is used to generate the various individual updates Ûⱼ. The key challenge is making sure \hat{B} is succinct. Both cases will make use of a tSSB hash Π_{tSSB}=(Gen_{tSSB}, H, Open, Ver_{tSSB}) with sufficiently large symbol set [symbol] ^{Σ}. We will also assume that Π_{tSSB} can be set to be binding on up to two indices, which as discussed in Remark 9, is without loss of generality.

The partitioned case. Let Z be a list of (idⱼ, zⱼ) pairs, j ∈ [L], where zⱼ is a bit indicating to either authorize or unauthorize user idⱼ. Let

$$\\ {vk}_{0}^{( 0 )} , {vk}_{1}^{( 0 )}$$

be the current verification keys in pk.

To batch updates in L together, sample a punctured PRF key k←{0, 1}^{λ} and hash key hk←Gen_{tSSB} (1^{λ}, L, Z, 1) and let h=H(hk, Z). Then let

$$\\ \hat{B} ← iO ( {1}^{λ} , B [ {vk}_{0}^{( 0 )} , {vk}_{1}^{( 0 )} , hk , h , k , L ] )$$

where B is the program in Table 5. Let um=(Z, \hat{B}).

Also let

$$\\ ( {r}_{0}^{L} , {r}_{1}^{L} , {s}^{L} ) ← F ( k , j ) and$$

$$\\ ( {sk}_{0}^{( L )} , {vk}_{0}^{( L )} ) ← Gen ( {1}^{λ} ; {r}_{0}^{L} ) , ( {sk}_{1}^{( L )} , {vk}_{1}^{( L )} ) ← Gen ( {1}^{λ} ; {r}_{1}^{L} ) .$$

### Let

$$\\ {g}^{′} ← {Enc}_{pke} ( ek , {sk}_{0}^{( L )} ‖ {sk}_{1}^{( L )} ) .$$

### Let

$$\\ {pk}^{′} ← ( ek , {vk}_{0}^{( L )} , {vk}_{1}^{( L )} , {g}^{′} ) .$$

For user id to update their key, they parse um as a program \hat{B}, let

$$\\ {usk}_{id}^{0} = {usk}_{id} ,$$

and then they simply do the following for j=1, . . . , L:
(1) Run Û←\hat{B}(idⱼ, zⱼ, j, Open(hk, Z, j).
(2) Run

$$\\ {usk}_{id}^{j} ← UpK ( \hat{U} , id , {usk}_{id}^{j - 1} ) .$$

Then they finally output

$$\\ {usk}_{id}^{L} .$$

The recipient private case. Notice that the batch update above explicitly leaks the list of updates Z, so there is no hope of recipient privacy for such an update. Here, we explain how to make the above idea recipient private. Essentially, we will encrypt the update list,

TABLE 5
$B [ {vk}_{0}^{( 0 )} , {vk}_{1}^{( 0 )} , hk , h , k , L ]$

Inputs: id, z, j ∈ [L], π
$Constants \text{:} {vk}_{0}^{( 0 )} , {vk}_{1}^{( 0 )} , hk , h , k , L$
(1) If Ver_{tSSB} (hk, h, j, (id, z), π) = 0, abort; output ⊥
$( 2 ) ( {r}_{0}^{j} , {r}_{1}^{j} , {s}^{j} ) ← F ( k , j )$
$( 3 ) ( {sk}_{0}^{( j )} , {vk}_{0}^{( j )} ) ← Gen ( {1}^{λ} ; {r}_{0}^{j} ) , ( {sk}_{1}^{( j )} , {vk}_{1}^{( j )} ) ← Gen ( {1}^{λ} ; {r}_{1}^{j} )$
(4) If j > 1, let
$\begin{matrix}( {r}_{0}^{j - 1} , {r}_{1}^{j - 1} , {s}^{j - 1} ) ← F ( k , j - 1 ) \\ ( {sk}_{0}^{( j - 1 )} , {vk}_{0}^{( j - 1 )} ) ← Gen ( {1}^{λ} ; {r}_{0}^{j - 1} ) \\ ( {sk}_{1}^{( j - 1 )} , {vk}_{1}^{( j - 1 )} ) ← Gen ( {1}^{λ} ; {r}_{1}^{j - 1} )\end{matrix}$
$( 5 ) Output iO ( {1}^{λ} , U [ {vk}_{0}^{( j - 1 )} , {vk}_{1}^{( j - 1 )} , {sk}_{0}^{( j )} , {sk}_{1}^{( j )} , id , z ] ; {s}^{j} )$

and the obfuscated program in the update message will then decrypt it. What makes this case slightly non-trivial is that we cannot take advantage of arbitrary compression strategies for the set of updates Z. For example, if naively represented, the set Z requires |Z|×( [symbol] _{id}+1) bits, but this can be compressed into |Z|× [symbol] _{id}+log(|Z|) bits by simply recording the indexes with indicies to be authorized coming first. Then in order to know which indices to authorize vs unauthorize, we just need to remember how many of the indices are getting authorized. In order to get optimal batch updates, we need to hard-code this compression into the protocol.

To batch updates Z together, assume Z=((id₁, z₁), . . . , (id_{L}, z_{L})) is sorted so that all the updates which authorize a user come first, followed by the updates which make a use unauthorized. Let L′ be the number of authorization updates. Let Z′=(id₁, . . . , id_{L}) be just the identities in Z in the same order they appear in Z.

Sample a punctured PRF keys k, e←{0, 1}^{λ}. Let îdⱼ=idⱼ⊕F(e, j) and \hat{L}=(îd₁, . . . îd_{L}). Sample hash key hk←Gen_{tSSB} (1^{λ}), L, \hat{Z}, 1) and let h=H(hk, \hat{Z}).

Now let

$$\\ \hat{B} ← iO ( {1}^{λ} , {B}_{priv} [ {vk}_{0}^{( 0 )} , {vk}_{1}^{( 0 )} , hk , h , k , L , {L}^{′} ] )$$

where Bₚᵣᵢᵥ is the program in Table 6. Let um=(\hat{Z}, \hat{B}).

For user id to update their key, they parse um as a string \hat{Z} and a program \hat{B}, and let

$$\\ {usk}_{id}^{0} = {usk}_{id} .$$

Them they simply to the following for j=1, . . . , L:
(1) Run Û←\hat{B}(îdⱼ, j, Open(hk, \hat{Z}, j).
(2) Run

$$\\ {usk}_{id}^{j} ← UpK ( \hat{U} , id , {usk}_{id}^{j - 1} ) .$$

Then they finally output

$$\\ {usk}_{id}^{L} .$$

In Appendix 10, we explain how to prove security when using batch updates. The basic idea is to treat each batch update as initiating a sequence of epochs, one for each update in the batch. Then we update the proof of Lemma 2 and Theorem 4, so that when changing the puncturing status of some epoch, we make the corresponding hashing key hk binding on the index that corresponds to that epoch. This allows us to switch to a hybrid where, instead of the update message Û and the various vk and sk keys for that epoch being generated by \hat{B}, they are instead generated “freshly” as in the plain, unbatched security experiment. After

TABLE 6
${B}_{priv} [ {vk}_{0}^{( 0 )} , {vk}_{1}^{( 0 )} , hk , h , k , L , {L}^{′} ]$

Inputs: [symbol] , j ∈ [L], π
$Constants \text{:} {vk}_{0}^{( 0 )} , {vk}_{1}^{( 0 )} , hk , h , k , L , {L}^{′}$
(1) If Ver_{tSSB} (hk, h, j, id, π) = 0, abort; output ⊥
(2) id ← [symbol] ⊕ F(e, j)
$( 3 ) z = \{ \begin{matrix}1 & if j \leq {L}^{′} \\ 0 & if j > {L}^{′}\end{matrix}$
$( 4 ) ( {r}_{0}^{j} , {r}_{1}^{j} , {s}^{j} ) ← F ( k , j )$
$( 5 ) ( {sk}_{0}^{( j )} , {vk}_{0}^{( j )} ) ← Gen ( {1}^{λ} ; {r}_{0}^{j} ) , ( {sk}_{1}^{( j )} , {vk}_{1}^{( j )} ) ← Gen ( {1}^{λ} ; {r}_{1}^{j} )$
(6) If j > 1, let
$\begin{matrix}( {r}_{0}^{j - 1} , {r}_{1}^{j - 1} , {s}^{j - 1} ) ← F ( k , j - 1 ) \\ ( {sk}_{0}^{( j - 1 )} , {vk}_{0}^{( j - 1 )} ) ← Gen ( {1}^{λ} ; {r}_{0}^{j - 1} ) \\ ( {sk}_{1}^{( j - 1 )} , {vk}_{1}^{( j - 1 )} ) ← Gen ( {1}^{λ} ; {r}_{1}^{j - 1} )\end{matrix}$
$( 7 ) Output iO ( {1}^{λ} , U [ {vk}_{0}^{( j - 1 )} , {vk}_{1}^{( j - 1 )} , {sk}_{0}^{( j )} , {sk}_{1}^{( j )} , id , z ] ; {s}^{j} )$

generating them freshly, they are embedded into the program \hat{B}. Note that the terms for other epochs will still be generated by Û. Now we can apply Lemma 2 to the freshly generated terms to change its puncturing. After the epoch has been punctured or un-punctured, we can then switch back to having the terms for that epoch generated by \hat{B}, and then remove the binding of hk on that epoch. Since Theorem 4 only changes the puncturing status of one epoch at a time, we only ever need to be binding on a single epoch, which allows the proof of Theorem 4 to go through.

### 6 Correctness and History Independence in Stateful Broadcast Encryption

Correctness. We now define correctness for stateful broadcast encryption. Let λ be the security parameter. Consider the following experiment Exp^{Corr} (λ, [symbol] ) between an unbounded adversary [symbol] and challenger:
(1) [symbol] , on input 1^{λ}, returns [symbol] .
(2) The challenger runs (pk, gmsk)←Init(1^{λ}), [symbol] ) and sends pk, gmsk to [symbol] . The challenger initializes sets Auth={ } (indicating authorized users) and Reg={ } (indicating registered users).
(3) [symbol] can now make several kinds of queries, in any order:
   (a) KeyGen: [symbol] submits a pair (id, z) ∈ {0, 1 [symbol] ×{0, 1}. The challenger computes usk_{id}←KeyGen(gmsk, pk, id, z). If id ∈ Reg already, then there is a previous value of usk_{id}, which is over-written by the newly computed value. If id ∉ Reg, add id to Reg. The challenger sends usk_{id} to [symbol] . If z=1, the challenger adds id to Auth; if z=0, the challenger removes id from Auth.
   (b) Authorize: [symbol] submits a pair (id, z) ∈ ({0, 1 [symbol] ×{0, 1})∪ {(⊥, ⊥)}. In response, the current epoch ends. The challenger adds or removes id from Auth based on the bit z (if(id, z)=(⊥, ⊥), Auth is unchanged). It also runs (pk′, um)←UpAuth(pk, (id, z)), and sends pk′, um to [symbol] . If id ∈ Reg, the challenger runs

$$\\ {usk}_{id}^{′} ← UpK ( um , id , {usk}_{id} ) ,$$

and then replaces usk_{id} with

$$\\ {usk}_{id}^{′} .$$

The challenger replaces pk with pk′. The challenger then sends pk′ to [symbol] , as well as

$${usk}_{id}^{′}$$

if id ∈ reg.
(c) Challenge: [symbol] submits an identity/message pair (id, m). If id ∉ Auth or id ∉ Reg, the challenger does nothing. If id ∈ Auth∩Reg, the challenger computes c←Enc(pk, m) where pk is the current value of the public key. Then the challenger computes m′←Dec(id, usk_{id}, c) (since id ∈ Reg, the challenger is guaranteed to have some value for usk_{id}). The adversary wins if m′≠m. Otherwise, the game continues.

[symbol] can make any polynomial number of the above queries with any values in any order. If at the end of the experiment the adversary has not yet won, the adversary loses. The output of the experiment is 1 if the adversary wins and 0 otherwise.

Definition 10. We say that a broadcast encryption scheme is correct if, for all potentially computationally unbounded adversaries [symbol] making at most a polynomial number of queries, there exists a negligible function negl(λ) such that, for all security parameters λ, Pr[1←Exp^{Corr} (λ, [symbol] )]≤negl(λ).

Note that the definition above gives the unbounded adversary access to the group manager secret key, as well as all the user secret keys. One can consider weaker notions of correctness where this is not the case, or where the adversary is constrained to be polynomial-time computable. We will not need to consider these weaker notions in this work.

History Independence. We formally define this notion through an experiment Exp^{HistIndep} (λ, [symbol] ) between an unbounded adversary [symbol] and challenger:
(1) The challenger runs (pk, gmsk)←Init(1^{λ}) and sends pk to [symbol] . It initializes a table L of tuples (id, z, usk_{id}). Initially L is empty.
(2) [symbol] can now make several kinds of queries, in any order:
   (a) Corrupt: [symbol] submits an identity id ∈ {0, 1 [symbol] ×{0, 1}. For z=0, 1, the challenger computes usk_{id, z}←KeyGen(gmsk, pk, id, z) and sends them to [symbol] .
      For z=0, 1, the challenger also checks if there is an existing tuple of the form

$$( id , z , {usk}_{id , z}^{′} )$$

in L, for some

$${usk}_{id , z}^{′} .$$

If so, and if

$${usk}_{id , z}^{′} \neq {usk}_{id , z} ,$$

the challenger immediately aborts and [symbol] wins. Otherwise, the challenger adds (id, z, usk_{id, z}) to L (if it did not already exist).
(b) Authorize: [symbol] submits a pair (id, z) ∈ ({0, 1 [symbol] ×{0, 1})∪{(⊥, ⊥)}. The challenger then runs (pk′, um)←UpAuth(pk, (id, z)), and sends pk′, um to [symbol] . The challenger replaces pk with pk′.
   For all tuples (id′, z′, usk_{id′, z′}) ∈ L with id′≠id, the challenger deletes the tuple from L, computes

$${usk}_{{id}^{′} , {z}^{′}}^{′} ← UpK ( um , {id}^{′} , {sk}_{{id}^{′} , {z}^{′}} )$$

and adds the tuple

$$( {id}^{′} , {z}^{′} , {usk}_{{id}^{′} , {z}^{′}}^{′} )$$

to L.
For tuples (id, z′, usk_{id′, z′}) ∈ L, the challenger deletes the tuple from L and computes

$${usk}_{id , {z}^{′}}^{′} ← UpK ( um , id , {sk}_{id , {z}^{′}} ) .$$

If there is such a tuple for both z′=0, 1, the challenger checks that

$${usk}_{id , 0}^{′} = {usk}_{id , 1}^{′} ;$$

if not the challenger immediately aborts and [symbol] wins. Otherwise, the challenger adds the tuple (id, z, usk_{id, z}) to L.

[symbol] can make any polynomial number of the above queries with any values in any order. If at the end of the experiment the adversary has not yet won, the adversary loses. The output of the experiment is 1 if the adversary wins and 0 otherwise.

Definition 11. We say that a broadcast encryption scheme is history independent if, for all potentially computationally unbounded adversaries [symbol] making at most a polynomial number of queries, there exists a negligible function negl(λ) such that, for all security parameters λ, Pr[1←Exp^{HistIndep} (λ, [symbol] )]≤negl(λ).

### 7 Tracing in Stateful Broadcast

Defining Tracing. A broadcast scheme is traceable if no coalition of users can output a useful pirate decoder which cannot be traced back to some user in the coalition. More precisely, there is an algorithm Trace^{D}(pk, q, ϵ, m₀, m₁) which takes as input a bound on the number of users q, a goodness threshold ϵ and two messages m₀, m₁. It runs in time polynomial in λ, 1/ϵ, q and can make queries to the pirate decoder D produced by the adversary. We assume that the decoder D is stateless, so that the state of D is reset to its original state after reach query. Then Trace tries to accuse at least one user controlled by the adversary. This is formalized by the following experiment

$${Exp}_{ϵ}^{Trace} ( λ , 𝒜 ) :$$

(1) The game starts out identically to Exp^{IND} (λ, [symbol] ), except that there is no challenge query, no bit DidChal, and no aborting if DidChal=1ΛCorr₁≠∅.
(2) Eventually, [symbol] outputs the description of a pirate decoder D and two messages m₀, m₁ of the same length. The challenger runs Acc←Trace^{D} (pk, q, ϵ(λ), m₀, m₁) to get a set of accused users, where pk is the current value of the public key. The challenger also checks that Pr[D(Enc(pk, m_{b}))=b]≥1/2+ϵ(λ), where the probability is taken over a random bit b and the randomness of Enc, D. In this case, we say that D is ϵ(λ)-good. [symbol] wins if either (1) Acc≮Corr₁ (some user is accused that is not both corrupted and authorized) or (2) both D is ϵ(λ)-good and Acc=∅) (Trace fails to trace a good decoder to at least one user). The output of the experiment is 1 if the adversary wins and 0 otherwise.

Definition 12. We say that a broadcast encryption scheme is traceable if, for all adversaries [symbol] and all inverse polynomials ϵ, there exists a negligible function negl(λ) such that

$$Pr [ 1 ← {Exp}_{ϵ}^{Trace} ( λ , 𝒜 ) ] \leq negl ( λ ) .$$

Remark 11. Typically in the tracing literature, and also in this work, Trace is assumed to only need black-box access to D. We can also consider white-box access, where Trace is given the actual code for D. Such a notion was considered in Zhandry21, which can be used to achieve certain characteristics that are not possible with black-box tracing. We leave adapting the techniques of Zhandry21 to the tracing of stateful broadcast as a direction for future work.

Remark 12. For broadcast schemes that are not history independent, as with indistinguishability security, we would need to update the definition to also allow for the adversary to corrupt existing users, whose secret keys have been updated through a sequence of UpK operations.

Remark 13. Most of the traitor tracing literature assumes stateless decoders, and in particular the ability for the tracing algorithm to reset the decoder to its original state. We work in this model as well. Note that this notion of “stateless” applies to the pirate decoder produced by the adversary, and is independent of the question of whether the honest receivers are stateless of stateful.

Tracing from Augmented Broadcast Encryption.

Lemma 3. Suppose Π is a secure Augmented BE. Then it is traceable.

Proof. This follows similar ideas as in BonWat06. The key difference is that, because we are in the identity-based (non-indexed) setting, our tracing algorithm cannot simply scan the entire identity-space. Instead, we must use the algorithms of NisWicZha16. Towards that end, we recall a definition and theorem adapted from NisWicZha16:

Definition 13 (NisWicZha16). An instance of the (N, q, δ, ϵ) noisy jump finding problem is specified by a subset C⊆[1, N] of q unknown points and a function P:[0, N]→[0, 1 [symbol] with the guarantee that:
(1) |P(N)−P(0)|>ϵ. That is, over the entire domain, P varies significantly.
(2) For any interval (T₀, T₁]⊂[1, N] that does not contain any points in C (that is, (T₀, T₁]∩C=∅), it must be |P(T₀)−P(T₁)|<δ. That is, outside the points in C, P varies very little.

We are now allowed to interact with a randomized oracle Q: [0, N]→{0, 1} defined as follows: Q(T) chooses and outputs a random bit that is 1 with probability P(T), and 0 otherwise. A fresh sample is chosen for repeated calls to Q(T), and is independent of all other samples outputted by Q. An algorithm A solves the (N, q, δ, ϵ) noisy jump-finding problem with probability p if, for all instances, A outputs an id ∈ C with probability at least p (where the probability is taken over the randomness of A and the randomness of Q).

Theorem 7 (NisWicZha16). There is a probabilistic algorithm QTrace^{Q}(N, q, δ, λ) that runs in time t=poly(log N, q, 1/δ, ∥) (and in particular makes at most t queries to Q) that for all instances of the (N, q, δ, ϵ) noisy jump finding problem will output an id ∈ C with probability 1−negl(λ), provided ϵ>δ(5+2(┌log N┐−1)q). Furthermore, the algorithm never outputs an element outside C, regardless of the relationship between ϵ and δ.

The algorithm Trace. Let Trace^{D} (pk, ϵ, q, m₀, m₁) be the following algorithm:
(1) Set δ=ϵ/2(5+2(┌log N┐−1)q).
(2) Let Q(T) be a probabilistic sub-routine which does the following: sample a random bit b, compute c←Enc(pk, m_{b}, T), run b′←D(c), and output 1⊕b′⊕b.
(3) Run and output x←QTrace^{Q} (N, q, δ, λ).

It suffices to show that if D is e-good, then Q(T) is an instance of the (N, q, δ, ϵ′=ϵ/2) noisy jump finding problem with C being the set of authorized corrupted users. To see this, let P(T) be the probability that D(Enc(pk, m_{b}, T))=b. Then we have that P( [symbol] )≥1/2+ϵ since Enc(pk, m_{b}, T)=Enc(pk, m_{b}). We also have that P(0)=1/2+negl(λ)≤1/2+ϵ/2, by message hiding. Thus |P( [symbol] )−P(0)|≥ϵ/2=ϵ′.

Now consider two values T₀, T₁ made as queries by QTrace to Q. Suppose that (T₀, T₁]∩C=∅. Then by index hiding, and the fact that QTrace is polynomial time, we must have |P(T₀)−P(T₁)|≤negl(λ)≤δ. Thus from the perspective of QTrace, Q is an instance of the (N, q, δ, ϵ) noisy jump finding problem, and hence by Theorem 7, QTrace and thus Trace output an id ∈ C with overwhelming probability.

### 8 Relationship Between Stateful and Stateless Broadcast

We can recover the notion of stateless BE from our notion of stateful BE above by insisting on certain structural properties of the scheme:
(1) pk is divided into two parts, pk⁰ and the recipient set S. Likewise usk_{id} is divided into

$${usk}_{id}^{0}$$

and S, where it is assured that all parties have the same S
(2) UpAuth(pk, id, z) parses pk as (pk⁰, S), adds or removes id from S to get S′, and then outputs pk′=(pk⁰, S′) and um=(id, z).
(3) UpK(um, usk_{id}) parses usk_{id} as

$$( {usk}_{id}^{0} , S )$$

and um=(id, b), and then and adds or removes id from S to get S′. The new secret key is

$${usk}_{id}^{′} = ( {usk}_{id}^{0} , {S}^{′} ) .$$

(4) KeyGen(gmsk, pk, id, z) is assumed to only operate with z set to be the current authorization status of id as revealed by S that is a part of pk. The generation of

$${usk}_{id}^{0}$$

(as part of

$${usk}_{id} = ( {usk}_{id}^{0} , S ) )$$

only depends on gmsk, and is in particular independent of the current recipient set S.

Observe that a scheme meeting the requirements never has pk⁰ or

$${usk}_{id}^{0}$$

change. Hence, if we consider pk⁰ as the public key and

$${usk}_{i}^{0}$$

as the secret key, we obtain a stateless scheme.

In the stateless broadcast literature, we typically only count the sizes of pk⁰,

$${usk}_{i}^{0}$$

rather than the entire public key and secret keys. If pk⁰ or

$${usk}_{i}^{0}$$

are size poly(λ), we say that the sizes of those components are optimal. The various notion of security for stateful BE discussed above (AD-IND, tracing, recipient privacy) immediately yield the analogous notions for stateful broadcast when viewing stateless BE as a special case of stateful BE.

In a stateless scheme, the ciphertext size must always be at least N+ω(log λ), which we would call optimal. This does not quite capture the usual syntax of BE, which typically separates the N+poly(λ) bits of the ciphertext into an explicit description of the recipient set plus an poly(λ) bit header. We call a scheme of this form partitioned. The disadvantage of a partitioned scheme is that recipient privacy is not possible. The advantage of such a partitioned scheme is that it may be able to take advantage of other mechanisms for communicating the recipient set, or benefit from special cases where the recipient set can be encoded efficiently (such as when all but a few users are authorized). We say a partitioned stateless BE has optimal ciphertext size if the header has size poly(λ).

Batched Reset Implies Stateless BE. Here, we observe that stateful BE with batch updates/reset implies the stateless variant with good parameters:

Theorem 8. If there exists an optimal AD-IND secure stateful identity-based (resp. index based) BE with optimal batch updates or optimal batch reset, then there exists an AD-IND secure stateless identity-based (resp. index based) BE with optimal parameters. If the stateful scheme is traceable or recipient private, then so is the stateless scheme. If the updates of the stateful scheme are partitioned, then the ciphertexts in the stateless scheme are partitioned.

Proof. Init is identical to the stateful scheme, up to the syntactic changes discussed above, with pk⁰ for the stateless scheme being set to pk from the stateful scheme. KeyGen is identical, except that we always use z=0. We set

$${usk}_{id}^{0}$$

in the stateless scheme to be usk_{id} from the stateless scheme.

To encrypt to a set of users S, first run the batch update/reset to add the users in S to the authorized user set. This produces an update message um and new public key pk′. Now encrypt to pk′, obtaining ciphertext c. The stateless ciphertext is then (um, pk′, c). To decrypt, each user runs UpK using pk′ to obtain

$${usk}_{id}^{′} ,$$

which they use to decrypt c. Unlike the stateful scheme, they then discard pk′,

$${usk}_{id}^{′} ,$$

reverting back to the original pk, usk_{id}. Correctness, the various forms of security, and parameter sizes follow immediately from the corresponding features of the underlying stateful scheme.
9 More on tSSB Hashing
9.1 SPB Hashing from Homomorphic Encryption

Here, we briefly discuss how SPB hashes can also be constructed from multiplicatively or additively homomorphic encryption. The idea is inspired by the FHE-based construction of SSB hashes in HubWic15, but adapted to work with the milder requirement of SPB hashing and milder structure of multiplicatively/additively homomorphic encryption. This gives a way to realize tSSB hashes from assumptions other than iO that may also be milder than what is possible plain SSB hashing.

We first consider the multiplicative homomorpism case. For a desired input length [symbol] ₓ, hk will consist of 2× [symbol] ₓ ciphertexts c_{j, b} for j ∈ [ [symbol] ₓ], b ∈ {0, 1}. To generate hk←Gene_{SPB}(1^{λ}), x*), set

$${c}_{j , {x}_{j}^{*}}$$

to be all encryption of 1 and

$${c}_{j , 1 - {x}_{j}^{*}}$$

to be an encryption of 0. SPB security follows from the CPA security of the encryption scheme. To hash a string x, simply homomorphically multiply the ciphertexts c_{j, x}_{ⱼ}. Observe that the hash of x* will be an encryption of 1, while the hash of any x≠x* will be an encryption of 0. Therefore, no input can collide with x*.

Now consider the additive homomorphism case. Suppose the plaintext space is [symbol] ₚ for p> [symbol] ₓ. The same construction as above works, except that we homomorphically add instead of multiply. The hash of x* will now be an encryption of the integer [symbol] ₓ, while the hash of any x≠x* will be an encryption of [symbol] ₓ−|x−x*|₁< [symbol] ₓ. Therefore, no input can collide with x*.

Remark 14. If we were to ignore the size of the hash key hk, we can also directly construct an (even non-targeted) SSB hash from a singly homomorphic scheme. As above, the hash key will consist of 2× [symbol] ₓ ciphertexts c_{j, b}. For the binding position i, c_{i,b} will be an encryption of b. For the additive homomorphism case, c_{j,b} for j≠i will be an encryption of 0; for multiplicative homomorphisms, c_{j,b} will be encryptions of 1. To hash a string x, simply homomorphically combine the ciphertexts c_{j,x}_{ⱼ} which will yield in either case an encryption of xᵢ, which is thus binding at index i. The problem is that the hash key is larger than the input. This is not an issue with SPB hashes (there is no need for hash key succinctness) but will not be useful in most applications of (t) SSB hashes.

### 10 More on Batched Updates

10.1 Changing the Status of all Users with Recipient Privacy

Before getting into the security proof, we also mention how to change the status off all users with recipient privacy. If we are changing the status of all N users, the prior batching results in update messages of size N×log(N)+poly(λ). But only N bits are actually required to indicate the authorization status of the N users. Therefore, we would hope to achieve an update message of N+poly(λ) bits in this case. Note that for a partitioned scheme, we can always compress the list Z to whatever the optimal compression is, so in a partitioned scheme we automateically achieve update messages of N+poly(λ) bits in this setting. However, for recipient private schemes, we have to modify the approach above in order to take advantage of the more compact representation.

Let Z ∈ {0, 1}^{N} denote the indicator vector where we intend to update the status of user i according to bit Zᵢ.

Sample a punctured PRF keys k, e←{0, 1}^{λ}. Let \hat{z}ⱼ=Zⱼ ⊕F(e, j) and \hat{Z}=(\hat{z}₁, . . . \hat{z}_{N}). Sample hash key hk←Gen_{tSSB} (1^{λ}, N, \hat{Z}, 1) and let h=H(hk, \hat{Z}).

Now let

$$\hat{B} ← iO ( {1}^{λ} , {B}_{priv , 2} [ {vk}_{0}^{( 0 )} , {vk}_{1}^{( 0 )} , hk , h , k , N ] )$$

where B_{priv,2} is the program in Table 7. Let um=(\hat{Z}, \hat{B}).

For user id to update their key, they parse um as a string \hat{Z} and a program \hat{B}, and let

$${usk}_{id}^{0} = {usk}_{id} .$$

Then they simply do the following for j=1, . . . , N:
(1) Run Û←\hat{B}(\hat{z}ⱼ, j, Open(hk, \hat{Z}, j)).
(2) Run

$${usk}_{id}^{j} ← UpK ( \hat{U} , id , {usk}_{id}^{j - 1} ) .$$

Then they finally output

$${usk}_{id}^{N} .$$

### 11 Constructing Identity-Based Broadcast Encryption

Here, we improve on Construction 3 in Section 5 to make it identity-based. We first point out that the only reason we cannot set the identity space in Construction 3 to be large is that the security proof uses a hybrid argument that iterates over all identities in the identity space. As such, the security loss is super-polynomial. We could, by making sub-exponential

TABLE 7
${B}_{priv , 2} [ {vk}_{0}^{( 0 )} , {vk}_{1}^{( 0 )} , hk , h , k , N ]$

Inputs: \tilde{z}, j ∈ [N], π
$Constants \text{:} {vk}_{0}^{( 0 )} , {vk}_{1}^{( 0 )} , hk , h , k , N$
(1) If Ver_{tSSB}(hk, h, j, \tilde{z}, π) = 0, abort; output ⊥
(2) z ← \tilde{z} ⊕F(e, j)
$( 3 ) ( {r}_{0}^{j} , {r}_{1}^{j} , {s}^{j} ) ← F ( k , j )$
$( 4 ) ( {sk}_{0}^{( j )} , {vk}_{0}^{( j )} ) ← Gen ( {1}^{λ} ; {r}_{0}^{j} ) , ( {sk}_{1}^{( j )} , {vk}_{1}^{( j )} ) ← Gen ( {1}^{λ} ; {r}_{1}^{j} )$
(5) If j > 1, let
$\begin{matrix}( {r}_{0}^{j - 1} , {r}_{1}^{j - 1} , {s}^{j - 1} ) ← F ( k , j - 1 ) \\ ( {sk}_{0}^{( j - 1 )} , {vk}_{0}^{( j - 1 )} ) ← Gen ( {1}^{λ} ; {r}_{0}^{j - 1} ) \\ ( {sk}_{1}^{( j - 1 )} , {vk}_{1}^{( j - 1 )} ) ← Gen ( {1}^{λ} ; {r}_{1}^{j - 1} )\end{matrix}$
$( 6 ) Output iO ( {1}^{λ} , U [ {vk}_{0}^{( j - 1 )} , {vk}_{1}^{( j - 1 )} , {sk}_{0}^{( j )} , {sk}_{1}^{( j )} , j , z ] ; {s}^{j} )$

hardness assumptions, handle this loss and obtain a secure scheme. Here, we show how to modify the scheme to make it secure even under polynomial iO and one-way functions.

Construction overview. Recall that Construction 3 sets an authorized key for a user to be a signature on that user's index/identity relative to a verification key vk₁, and sets an unauthorized key for a user to be a signature relative to different vk₀. Here, however, to compute the key for a user id, we will first randomly generate a tag τ_{id}. Then signatures will be relative to the pair (τ_{id}, id). In the proof, we can mimic a similar proof strategy to that of Section 5, except that we iterate over the random tags τ_{id} given to corrupted users, instead of over all identities. Since the number of τ_{id} seen by the adversary is polynomial, there are only now a polynomial number of hybrid steps. This strategy requires constraining the signatures to more complex constraints than in Construction 3, but the necessary signatures can still be obtained from iO and one-way functions.

Construction 4 Let Π_{CSig}=(Gen, Sign, Ver, GenConstr) be a constrained signature scheme, which we will assume to have deterministic signing. Let [symbol] _{id} be any desired identity length and N= [symbol] ; we will interpret the identity space {0, 1 [symbol] as the set of integers [N] in an arbitrary way. Define Π_{BE}=(Init, UpAuth, UpK, Enc, Dec) as follows:
(1) Init(1^{λ}): Run (sk₀, vk₀), (sk₁, vk₁)←Gen(1^{λ) and (ek, dk)<Gen}ₚₖₑ (1^{λ). Run g←Enc}ₚₖₑ (ek, (sk₀, sk₁)). Set gmsk=dk and pk=(vk₀, vk₁, ek, g).
(2) KeyGen(gmsk, pk, id, z): Parse pk as (vk₀, vk₁, ek, g) and gmsk as dk, and run(sk₀, sk₁)←Decₚₖₑ (dk, g). Also sample a random tag τ_{id}←{0, 1}^{λ}. Output usk_{id}=(τ_{id}, σ_{id}) where σ_{id}←Sign(sk_{z}, (τ_{id}, id).
(3) UpAuth(pk, (id, z)): parse pk as (vk₀, vk₁, ek, g). Run

$$( {sk}_{0}^{′} , {vk}_{0}^{′} ) , ( {sk}_{1}^{′} , {vk}_{1}^{′} ) ← Gen ( {1}^{λ} ) .$$

Let

$${g}^{′} ← {Enc}_{pke} ( ek , ( {sk}_{0}^{′} , {sk}_{1}^{′} ) ) .$$

Let

$$\hat{U} ← iO ( {1}^{λ} , U [ {vk}_{0} , {vk}_{1} , {sk}_{0}^{′} , {sk}_{1}^{′} , id , z ] )$$

where U is the program in Table 8. Output

$${pk}^{′} = ( {vk}_{0}^{′} , {vk}_{1}^{′} , ek , {g}^{′} )$$

and um=Û.
(4) UpK(um, id, usk_{id}): Parse um as Û and usk_{id} as (τ_{id}, σ_{id}). Run

$${σ}_{i}^{′} ← \hat{U} ( id , {𝒯}_{id} , {σ}_{id} ) .$$

Output

$${usk}_{id}^{′} = ( {𝒯}_{id} , {σ}_{id}^{′} ) .$$

(5) Enc(pk, m): Parse pk as (vk₀, vk₁, ek, g). Output Ê←iO(1^{λ), E[vk}₁, m, 2^{λ}×N]), where E is the program in Table 9. In the description of E, we interpret pairs (τ, id) as integers in the natural lexicographic way.
(6) Dec(id, usk_{id}, Ê): Parse usk_{id}=(τ_{id}, σ_{id}). Output the decrypted message m′←Ê(id, τ_{id}, σ_{id}).

TABLE 8
$U [ {vk}_{0} , {vk}_{1} , {sk}_{0}^{′} , {sk}_{1}^{′} , id , z ]$

| Inputs: u, τ, σ | |
|---|---|
| $Constants \text{:} {vk}_{0} , {vk}_{1} , {sk}_{0}^{′} , {sk}_{1}^{′} , id , z$ | |
| (1) If Ver(vk₀, (τ, u), σ) = 0 ∧ Ver(vk₁, (τ, u), σ) = 0: | |
| | abort; output ⊥ |

$( 2 ) b ← \{ \begin{matrix}0 & if u \neq id ⋀ Ver ( {vk}_{0} , ( τ , u ) , σ ) = 1 \\ 1 & if u \neq id ⋀ Ver ( {vk}_{1} , ( τ , u ) , σ ) = 1 \\ z & if u = id\end{matrix}$
$( 3 ) Output Sign ( {sk}_{b}^{′} , ( τ , u ) )$

TABLE 9
E[vk, m, j]

Inputs: u, τ, σ
Constants: vk, m
(1) If (τ, u) > j:

abort; output ⊥

(2) If Ver(vk, (τ, u), σ) = 0:

abort; output ⊥

(3) Output m

The correctness of our protocol follows readily from the correctness of the underlying building blocks. To see this, observe that
sigma_{id} is always a signature relative to vk_{z} on the pair (τ_{id}, id), where z is the bit indicating whether or not id is in the authorized user set. Assuming that Π_{CSig} has deterministic signing, it is also clear that the protocol is history independent. We now prove security.

### 11.1 Puncturing Theorems

Here, we give a puncturing theorem for Construction 4 akin to the puncturing results for Construction 3.

First, in any security experiment, for the τ that will be generated during corruption queries, we can switch to the τ being generated at the beginning of the experiment. Since the adversary only makes a polynomial number of corruption queries, we can assume (incurring only an exponentially small loss) that the τ for different identities are distinct.

Now, at the beginning of the experiment, we do not know which id will be assigned to which τ, since we do not know which identities the adversary will corrupt. Instead, we will assign id's to τ's dynamically. In other words, let idᵢ be the ith identity corrupted by the adversary. While we do not know idᵢ until the experiment is under way, we can still assign each i to a unique τ; call this τᵢ.

We will give two kinds of puncturing: interstitial puncturing and tag puncturing.

Interstitial puncturing. Let τᵢ_{₁}<τᵢ_{₂} be two tags such that there are no other tags τᵢ with τᵢ_{₁}<τᵢ<τᵢ_{₂}. Then we say that an epoch t is interstitially punctured at the interval I=(τᵢ_{₁}, τᵢ_{₂}) if we make the following changes to the epoch:
(1) For both

$$z = 0 , 1 , {pk}_{z}^{t}$$

(the zth component of pk^{t} using 0-indexing) has been set to

$${( {vk}^{′} )}_{z}^{t} ,$$

where

$$( {( {vk}^{′} )}_{z}^{t} , {( {sk}^{\overline{I}} )}_{z}^{t} ) ← GenConstr ( {sk}_{z}^{t} , \overline{I} ) ,$$

where here Ī is interpreted as the constraint that rejects all pairs (τ, id) with τ ∈ I. Thus, there are no accepting signatures on pairs (τ, id) relative to

$${( {vk}^{′} )}_{z}^{t} ,$$

for τ ∈ I.
(2) um^{t} is set to

$$iO ( {1}^{λ} , U [ {pk}_{0}^{t - 1} , {pk}_{1}^{t - 1} , {S}_{0} , {S}_{1} , {id}^{t} , {z}^{t} ] )$$

where S_{z} has been set to

$${( {sk}^{\overline{I}} )}_{z}^{t}$$

instead of

$${sk}_{z}^{t}$$

for both z=0, 1.
(3) g^{t} has been set to Encₚₖₑ (ek, (S₀, S₁)) where S₀, S₁ have been modified as above.

Lemma 4. Suppose epoch t−1 is interstitially punctured at interval I. Then if Πₚₖₑ is a secure public key encryption scheme, iO is a secure indistinguishability obfuscator and Π_{CSig} is a secure constrained signature scheme, for any PPT adversary [symbol] , we can switch epoch t to be punctured at interstitially punctured at interval I, and this change is indistinguishable to [symbol] .

Theorem 9. For any interstitial interval I=(τᵢ_{₁}, τᵢ_{₂}), then if Πₚₖₑ is a secure public key encryption scheme, iO is a secure indistinguishability obfuscator and Π_{CSig} is a secure constrained signature scheme, we can puncture all epochs at interval I, and this change will be indistinguishable.

Tag puncturing. Here, we will discuss puncturing an epoch t at a tag/authorization pair (τᵢ, z). Intuitively, what this means is that, for whatever identities idᵢ is associated to tag τᵢ, there will not exist any user secret keys for that tag/identity pair with authorization status z. We will also insist that, if t is not also punctured at (τᵢ, 1−z), that there do not exist any user secret keys for any other tag/identity pair (τᵢ, id′) with id′≠idᵢ. This latter requirement is complicated by the fact that we only learn idᵢ dynamically, meaning we can only insist on it during epochs after idᵢ queried.

Let tᵢ be the epoch during which idᵢ is learned; that is, the epoch during which there is a corruption query on an id, which gets assigned to τᵢ. By guessing tᵢ, we can assume that the adversary commits to tᵢ at the beginning of the experiment, so we can assume tᵢ is known. Consider an epoch t. We say that t is punctured at (τᵢ, z) if we make the following changes to the epoch:
(1)

$${pk}_{z}^{t}$$

(the zth component of pk^{t} using 0-indexing) has been set to

$${( {vk}^{′} )}_{z}^{t}$$

instead of

$${vk}_{z}^{t} ,$$

where

$$( {( {vk}^{′} )}_{z}^{t} , {( {sk}^{\overline{{𝒯}_{i}}} )}_{z}^{t} ) ← GenConstr ( {sk}_{z}^{t} , \overline{{𝒯}_{i}} ) ,$$

where τ̅ᵢ̅ is interpreted as the constraint which rejects all pairs (τ, id) with τ=τᵢ.
(2) um^{t} is set to

$$iO ( {1}^{λ} , U [ {pk}_{0}^{𝓉 - 1} , {pk}_{1}^{𝓉 - 1} , {S}_{0} , {S}_{1} , {id}^{𝓉} , {𝓏}^{𝓉} ] )$$

where S_{z} has been set to

$${( {sk}^{\overline{{𝒯}_{i}}} )}_{𝓏}^{𝓉}$$

instead of

$${sk}_{𝓏}^{𝓉} .$$

For t≤tᵢ, we also set

$${S}_{1 - 𝓏} = {( {sk}^{\overline{{𝒯}_{𝒾}}} )}_{1 - 𝓏}^{𝓉} ,$$

while for t>tᵢ, we leave S_{1-z} as

$${sk}_{1 - 𝓏}^{{𝓉}^{*}} .$$

(3) g^{t} has been set to Encₚₖₑ (ek, (S₀, S₁)) where S₀, S₁ have been modified as above.
(4) The experiment will immediately abort and the adversary loses if ever

$${id}_{i} ∈ {Corr}_{z}^{t} .$$

In particular, the adversary loses if it ever makes a corruption query on (idᵢ, z) during epoch t.

Note that an epoch can also be punctured at both (id, 0) and (id, 1), in which case we change both

$${pk}_{0}^{𝓉} , {pk}_{1}^{𝓉}$$

and S₀, S₁. We will say that an epoch is unpunctured if pk^{t} and um^{t} are generated as in UpAuth pk^{t-1}, (id^{t}, z^{t}))).

Lemma 5 . . . Fix (t, i, z). Suppose the adversary guarantees that

$${id}_{i} ∉ {Corr}_{z}^{t} .$$

Assume no epoch is punctured except at pairs of the form (id, z′). Additionally assume any of the following conditions are met:
(1) t=1
(2)

$${id}_{𝒾} ∉ {Corr}_{0}^{𝓉 - 1} ⋃ {Corr}_{1}^{𝓉 - 1}$$

and epoch t-1 is punctured at both (idᵢ, 0) and (idᵢ, 1).
(3)

$${id}_{𝒾} ∈ {Corr}_{1 - 𝓏}^{𝓉 - 1} \backslash {Corr}_{𝓏}^{𝓉 - 1} ,$$

(id^{t}, z^{t})≠(idᵢ, z) and epoch t-1 is punctured at (idᵢ, z).
(4)

$${id}_{𝒾} ∈ {Corr}_{𝓏}^{𝓉 - 1}$$

and (idₜ, z^{t})=(idᵢ, 1−z).
(5) No epoch is punctured except at pairs of the form (id, z′).
   Then if Πₚₖₑ is a secure public key encryption scheme, iO is a secure indistinguishability obfuscator and Π_{PSig} is a secure punctured signature scheme, for any PPT adversary [symbol] , we can switch epoch t to be punctured at (τᵢ, z), and this change is indistinguishable to [symbol] .

Theorem 10. Consider a PPT adversary [symbol] which commits to an epoch t* and pair (i*, z*) at the beginning of the experiment. Then epoch t* is either punctured at (τ_{i*}, z*) or left unpunctured. In both cases, the experiment will immediately abort and the adversary loses if

$${id}_{{𝒾}^{*}} ∈ {Corr}_{{𝓏}^{*}}^{{𝓉}^{*}} .$$

If Πₚₖₑ is a secure public key encryption scheme, iO is a secure indistinguishability obfuscator and Π_{PSig} is a secure punctured signature scheme, then the punctured and unpunctured cases are computationally indistinguishable.

### 11.2 Augmented Stateful BE

We explain that Construction 4 is actually a slightly restricted form of an augmented BE scheme, where we consider the identity space to be pairs (τ, id), but instead of allowing the attacker to choose arbitrary pairs (τ, id) to corrupt, it can only choose identities id to corrupt and then the challenger chooses a random τ and corrupts (τ, id). In other words, it has all the functionality of an augmented BE scheme, but security is only guaranteed if the τ part of the identity is chosen honestly. To obtain such a scheme, we set Enc(pk, m, T) to output Ê←iO(1^{λ}), E[vk₁, m, T]), where E is the program in Table 9. Correctness follows immediately from the description of E.

Theorem 11. If Πₚₖₑ is a secure public key encryption scheme, iO is a secure indistinguishability obfuscator and Π_{PSig} is a secure punctured signature scheme, then protocol Π_{BE} in Construction 3 is a secure (restricted) augmented BE scheme.

Even though the augmented BE scheme only has restricted security, this is enough for applications since we will always choose the τ honestly. As immediate corollaries, by applying Lemmas 1 and 3, we obtain that Π_{BE} is both AD-IND secure and traceable. The proof of Theorem 11 is essentially identical to that of Theorem 5, except that we replace the use of Theorem 4 with Theorem 10.

### 11.3 Recipient Privacy

Theorem 12. If Πₚₖₑ, iO and Π_{PSig} are secure, then Construction 3 is adaptively recipient private.

The proof is essentially identical to that of Theorem 6, except that we replace the use of Theorem 4 with Theorem 10.

### 11.4 Batching Updates

We batch updates exactly as we batch updates in Section 5, just changing the update message program to output obfuscations of U from Table 3 to the U in Table 8. The proofs of security are identical.

### 12 Implementations

The various embodiments may be implemented within a variety of communication systems, networks and/or mobile multi-media broadcast systems, an example of which is illustrated in the Supplemental Figures.

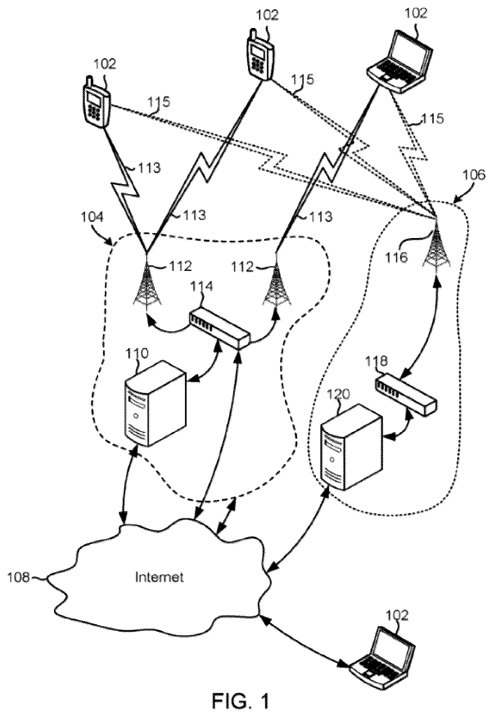

Specifically, FIG. 1 illustrates a communication system in which mobile receiver devices 102 may receive content from multimedia broadcast network 104, unicast network 106, or via the Internet 108. A typical multimedia broadcast network 104 includes a plurality of broadcast transmitters 112 controlled by a mobile broadcast network control center/broadcast operation center (BOC) 114. The multimedia broadcast network 104 broadcasts content from the broadcast transmitters 112 as mobile broadcast transmissions 113 for reception by the mobile receiver devices 102. Within the BOC 114, there may be one or more servers 110 for managing content broadcasts, and which provide a connection to the Internet 108.

In addition to the multimedia broadcast network 104, mobile receiver devices 102 may communicate via a unicast network 106, such as a cellular telephone network, WiFi network (not shown), WiMAX, etc. A typical cellular telephone network includes a plurality of cellular base stations 116 coupled to a network operations center 118. The network operations center 118 operates to connect voice and data calls between mobile receiver devices 102 and other network destinations, such as via telephone land lines (e.g., a POTS network, not shown) and the Internet 108.

Communications between mobile receiver devices 102 and the unicast network 106 may be accomplished via two-way wireless communication links 115 such as LTE, 4G, 3G, CDMA, TDMA, and other cellular telephone communication technologies. Such two-way wireless communication links 115 may enable users to stream multimedia content to receiver devices (e.g., mobile devices).

To facilitate Internet data communications (e.g., streaming video feeds), the unicast network 106 will typically include one or more servers 120 coupled to, or within, the network operations center 118 that provide a connection to the Internet 108. Mobile receiver devices 102 may further connect to the Internet 108 via a wired connection when available, in which case the Internet 108 may serve as the unicast network. Mobile receiver devices 102 may also receive non-broadcast content over the Internet 108 using well known conventional web-based access protocols.

Generally, the operations for receiving and rendering content by a receiver device (e.g., the mobile receiver devices 102 discussed above) may be divided into separate and independent groups or categories of operations, and each group or category of operations may be assigned to a layer (e.g., physical layer, data link layer, etc.). In each of these layers, various hardware and/or software components may implement functionality that is commensurate with responsibilities assigned to that layer. For example, media streams (e.g., broadcast, point-to-point, etc.) are typically received in the physical layer, which may include a radio receiver, buffers, and processing components that perform the operations of demodulating, recognizing symbols within the radio frequency (RF) signal, and performing other operations for extracting raw data from the received RF signal.

The broadcast network 104 may include a broadcast server 110 that connects to a broadcast transmitter 112. The broadcast transmitter 112 may emit a broadcast signal 113 that can be received by the mobile device 102. A broadcast control center 114 may manage the broadcast operations.

In some implementations, a wireless link 115 may connect the mobile device 102 to both the broadcast network 104 and cellular infrastructure. A cellular base station 116 may provide cellular network connectivity as part of the unicast network 106.

The network system may include a network operations center 118 that connects to a network server 120. Both these components may link to the internet network 108, enabling data flow between the broadcast network 104 and unicast network 106.

The network topology may combine both point-to-multipoint broadcasting through the broadcast transmitter 112 and point-to-point communication through the cellular base station 116. Data may flow through multiple paths, with the mobile device 102 capable of receiving information through either the broadcast signal 113 or the cellular network infrastructure.

In some cases, the system allows for communication between the mobile device 102 and the network infrastructure through both broadcast and unicast channels, with the internet network 108 serving as a central connecting point for the various network components.

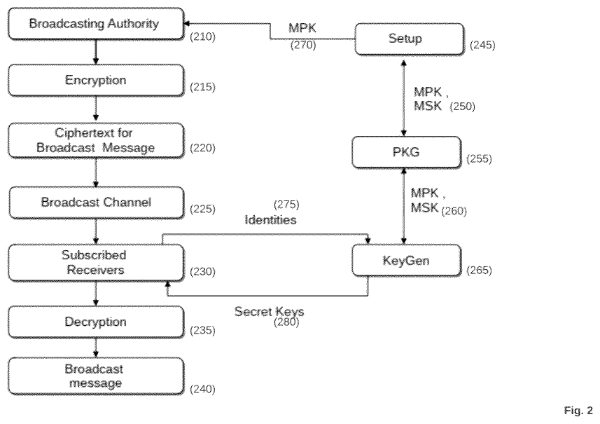

FIG. 2 illustrates an example computer-implemented method for the claimed broadcast encryption scheme. In the illustrated example embodiment, setup routine generates master public key (MPK) 270 and provides it to the broadcasting authority 210. The key operations 245, 255, 265 may be performed at a centralized or trusted authority or third-party, which may or may not be associated with or controlled by broadcast authority 210. The setup routine 245 also generates the master secret key (MSK) 250. Setup routine 245 may be called by the private key generator (PKG) 255. PKG 255 outputs system master public-key MPK 250 and the system master secret-key MSK 250, and makes MPK publicly available and keeps MSK as a secret. Key generation routine 265 receives the MPK and MSK, and user identities 275, and outputs secret keys 280 for each specific user.

Broadcasting authority 210 then employs MPK 270 to perform an encryption 215, which is then used as the ciphertext for a broadcast message 220. The broadcast message is then provided over a broadcast channel 225, which as described herein can take any wired or wireless form. The ciphertext is received by subscribed receivers 230 who have been provided with certain key material 280 in association with their identities 275 which have been provided to a key generation module 265. The secret keys 280 can be provided to receivers based on their identities 275. With the secret keys, the subscribed receivers can perform a decryption 235 of the broadcast ciphertext, and generate a resulting broadcast message 240.

In some cases, a secure broadcast messaging system may be implemented as shown in FIG. 2. The system may include multiple components that work together to enable secure communication between a broadcasting authority and subscribed receivers.

The process may begin with a setup step 245. During the setup step 245, a private key generator 255 may generate a master public key (MPK) and a master secret key (MSK). The master secret key 250 may be securely stored by the private key generator 255.

A key generation step 265 may follow the setup. In the key generation step 265, the private key generator 255 may use the master public key 260 and master secret key to generate secret keys 280 for subscribed receivers 230. The key generation may be based on identities 275 associated with the subscribed receivers 230.

A broadcasting authority 210 may initiate the secure broadcast process. The broadcasting authority 210 may receive the master public key 270 generated during setup. Using this master public key 270, the broadcasting authority 210 may perform an encryption step 215 on a broadcast message 220 to be sent.

The encrypted broadcast message may then be transmitted through a broadcast channel 225. The broadcast channel 225 may be a communication medium that allows the broadcasting authority 210 to send messages to multiple subscribed receivers 230 simultaneously.

Upon receiving the encrypted broadcast message, the subscribed receivers 230 may perform a decryption step 235. In the decryption step 235, each subscribed receiver 230 may use its unique secret key, previously generated in the key generation step 265, to decrypt the message.

After successful decryption, the subscribed receivers 230 may obtain the original broadcast message 240 sent by the broadcasting authority 210.

This system may provide secure communication by ensuring that only authorized subscribed receivers 230 with the appropriate secret keys can decrypt and access the broadcast messages. The use of unique secret keys for each receiver and the encryption of messages with the master public key may help maintain the confidentiality and integrity of the broadcast communications.

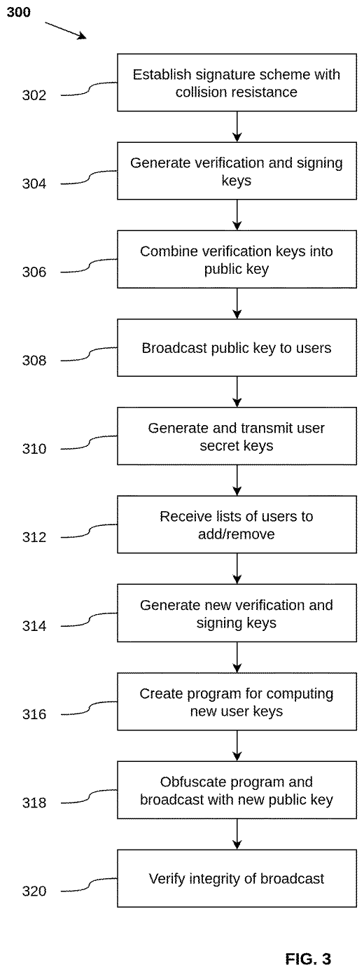

FIG. 3 illustrates a method 300 for managing a secure broadcast encryption system. The method 300 may comprise a sequence of steps for establishing and maintaining secure communications.

The method 300 may begin with a step 302, where a signature scheme with collision resistance may be established. In some cases, the signature scheme may be designed to prevent unauthorized parties from generating valid signatures.

Following the establishment of the signature scheme, a step 304 may involve generating verification and signing keys. These keys may be crucial components in ensuring the authenticity and integrity of the broadcast messages.

The method 300 may then proceed to a step 306, where verification keys may be combined into a public key. This combination may create a single, unified key that can be used for verification purposes by multiple recipients.

In a step 308, the public key may be broadcast to users. This broadcast may allow all authorized users to receive the necessary information for verifying future messages.

The method 300 may continue with a step 310, which may involve the generation and transmission of user secret keys. These secret keys may be unique to each user and may be essential for decrypting broadcast messages.

A step 312 may follow, where lists of users to add or remove may be received. This step may allow for dynamic management of the user base, enabling the addition of new authorized users or the removal of users who should no longer have access.

The process may continue with a step 314, where new verification and signing keys may be generated. This regeneration of keys may be a security measure to maintain the integrity of the system over time.

A step 316 may involve creating a program for computing new user keys. This program may be designed to update the keys of existing users or generate keys for newly added users.

The method 300 may then proceed to a step 318, where the program may be obfuscated and broadcast with the new public key. Obfuscation may help protect the program from reverse engineering or tampering attempts.

The method 300 may conclude with a step 320, which may involve verifying the integrity of the broadcast. This final step may ensure that the broadcast message and associated keys have not been altered during transmission.

In some cases, the method 300 may handle key generation, user management, and secure communication through a combination of signature schemes, key generation, and program obfuscation. The sequential nature of the steps in method 300 may allow for a structured approach to managing the broadcast encryption system, potentially enhancing security and efficiency.

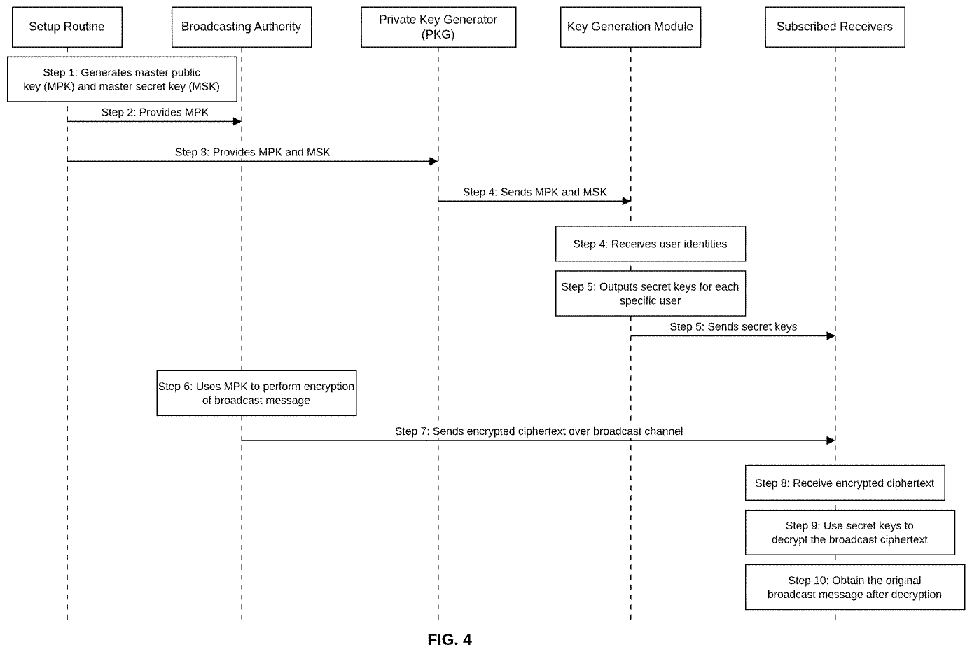

In some cases, a secure broadcast encryption system may be implemented using a sequence of operations involving multiple components. FIG. 4 illustrates an example sequence diagram showing the interactions between key components in such a system.

The sequence may begin with a Setup Routine generating both a master public key (MPK) and a master secret key (MSK). In some implementations, the Setup Routine may use cryptographic algorithms to derive these keys.

Following key generation, the MPK may be provided to a Broadcasting Authority. The Broadcasting Authority may use this public key for encrypting broadcast messages. Simultaneously, both the MPK and MSK may be sent to a Private Key Generator (PKG).

The PKG may then forward the MPK and MSK to a Key Generation Module. This module may perform two critical functions: receiving user identities and subsequently generating secret keys specific to each user. The generated user-specific secret keys may then be transmitted to Subscribed Receivers.

In parallel, the Broadcasting Authority may utilize the MPK to encrypt a broadcast message. The encryption process may involve applying cryptographic operations using the MPK to transform the plaintext message into ciphertext.

After encryption, the resulting ciphertext may be transmitted over a broadcast channel to reach the Subscribed Receivers. This broadcast channel may be a one-to-many communication medium, allowing efficient distribution of the encrypted message to multiple recipients simultaneously.

Upon receiving the encrypted ciphertext, the Subscribed Receivers may initiate a decryption process. This process may involve using the previously received secret keys to decrypt the broadcast ciphertext. The decryption operation may reverse the encryption process, transforming the ciphertext back into the original broadcast message.

In some implementations, the system may employ identity-based encryption techniques. Under this approach, user identities may serve as public keys, potentially simplifying key management processes.

The sequence described in FIG. 4 may provide a framework for secure broadcast communication. By separating key generation, encryption, and decryption processes across different components, the system may enhance security and enable efficient management of user access to broadcast content.

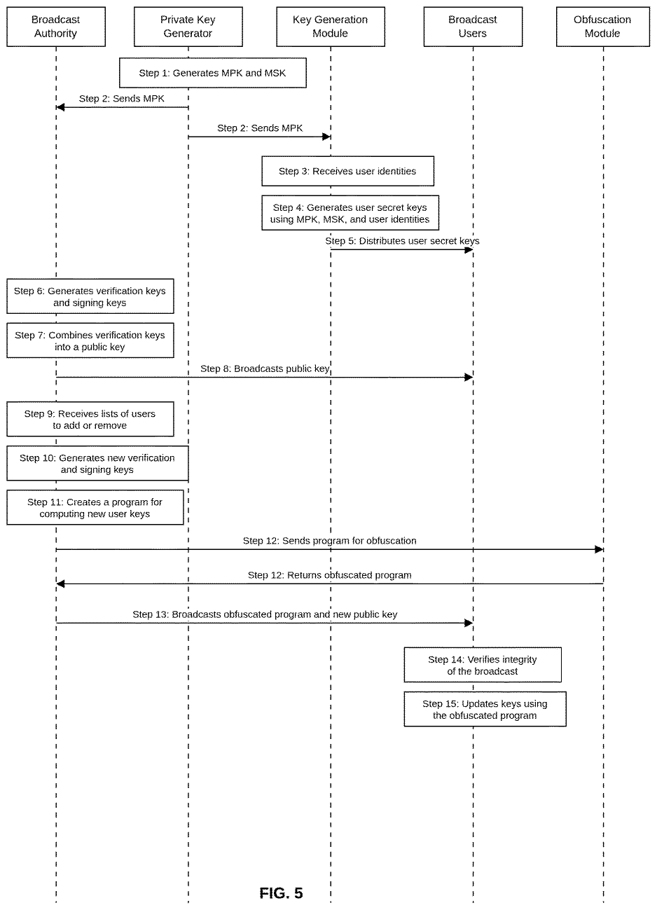

In some cases, a secure broadcast encryption system may utilize multiple components to manage key generation, distribution, and message encryption. FIG. 5 illustrates a sequence diagram showing the interactions between key components in such a system.

The sequence may begin with a Private Key Generator generating both a Master Public Key (MPK) and a Master Secret Key (MSK). In some implementations, the MPK may be distributed to both a Broadcast Authority and a Key Generation module.

The Key Generation module may receive user identities and proceed to generate user secret keys using the MPK, MSK, and user identities. These user secret keys may then be distributed to Broadcast Users.

In some cases, the Broadcast Authority may execute a series of steps including generating verification keys and signing keys, then combining verification keys into a public key. This public key may be broadcast to users.

The process may continue with the Broadcast Authority receiving lists of users to add or remove. This may trigger the generation of new verification and signing keys. The Broadcast Authority may then create a program for computing new user keys.

In some implementations, the sequence may incorporate an Obfuscation module. The program created by the Broadcast Authority may be sent to the Obfuscation module for obfuscation and returned in its obfuscated form to the Broadcast Authority. The Broadcast Authority may then broadcast both the obfuscated program and the new public key to users.

The sequence may conclude with Broadcast Users performing two final steps: verifying the integrity of the broadcast, and updating their keys using the obfuscated program.

This process may allow for secure key management and distribution in a broadcast encryption system, enabling the addition and removal of users while maintaining system security.

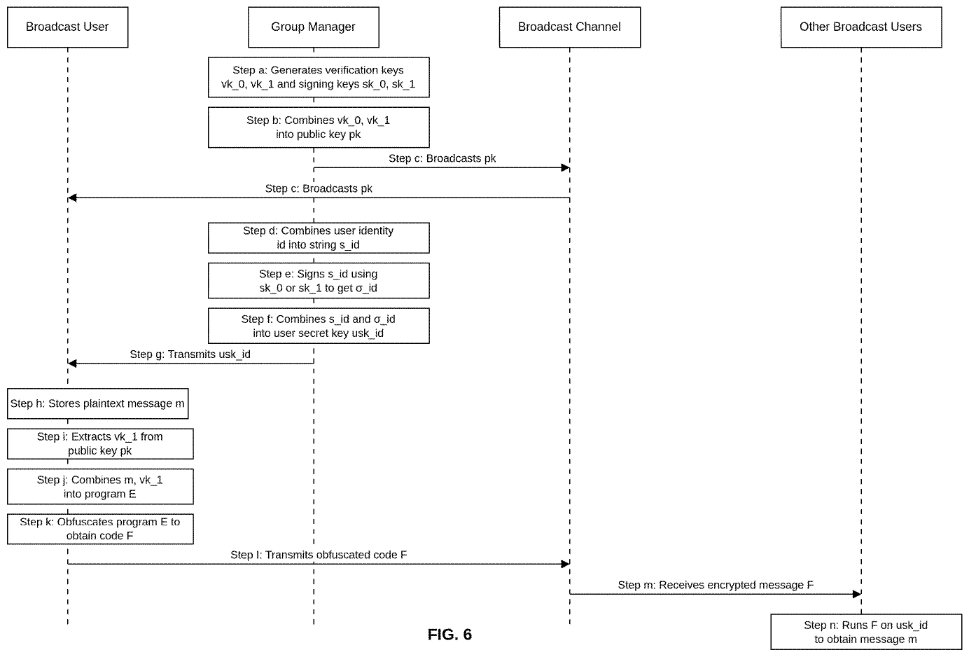

In some cases, a secure message transmission and encryption protocol may be implemented as illustrated in FIG. 6. The protocol may involve interactions between a Broadcast User, a Group Manager, a Broadcast Channel, and Other Broadcast Users.

The Group Manager may initiate the process by generating verification keys vk₀ and vk₁, as well as signing keys sk₀ and sk₁. The Group Manager may then combine vk₀ and vk₁ into a public key, denoted as pk. This public key may be broadcast through two paths-directly to the Broadcast Channel and to the Broadcast User.

Following the key generation, the Group Manager may perform several identity-related operations. The user identity may be combined into a string called s_{id}. The Group Manager may then sign this s_{id} using either sk₀ or sk₁ to obtain σ_{id}. These components may be combined into a user secret key, denoted as usk_{id}, which may be transmitted to the Broadcast User.

The Broadcast User may then execute a series of message preparation steps. Initially, a plaintext message m may be stored. The Broadcast User may extract vk₁ from the previously received public key pk. The message m and vk₁ may be combined into a program E, which may then be obfuscated to create code F.

The obfuscated code F may follow a transmission path through the Broadcast Channel, which may forward the encrypted message F to Other Broadcast Users. The process may conclude with Other Broadcast Users running F against their usk_{id} to obtain the original message m.

In some implementations, this protocol may create a secure chain of encryption, transmission, and decryption that may ensure message confidentiality while allowing authorized users to access the content. The use of verification keys, signing keys, and obfuscation techniques may contribute to the security of the system.

Each step in this process may build upon the previous ones, potentially enhancing the overall security of the message transmission. The combination of key generation, identity-based operations, and obfuscation may provide multiple layers of protection for the transmitted messages.

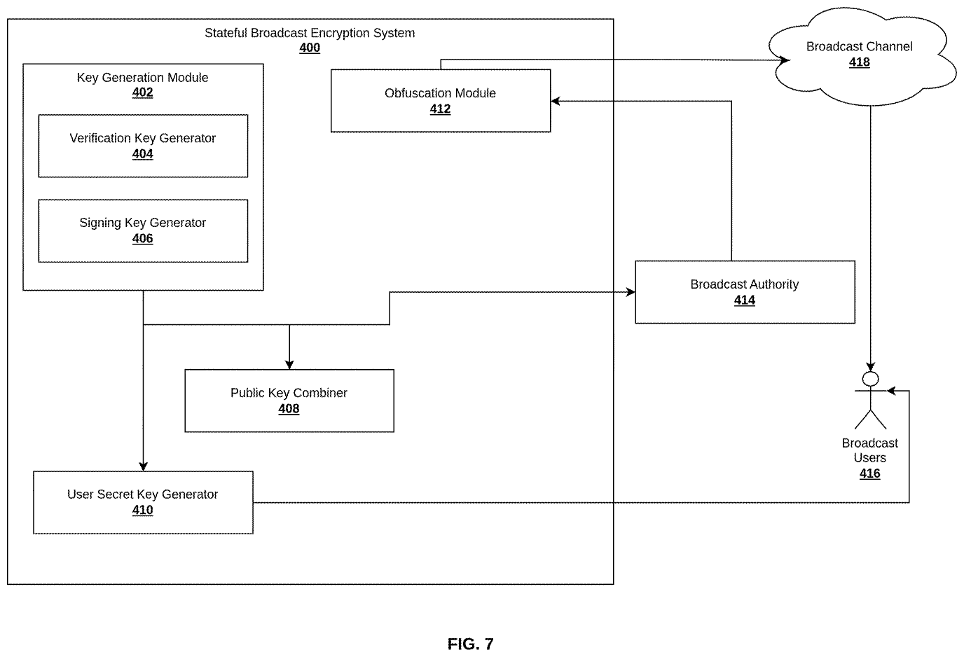

FIG. 7 illustrates a stateful broadcast encryption system 400. The encryption system 400 may include a key generation module 402, an obfuscation module 412, and components for transmitting through a broadcast channel 418.

In some cases, the key generation module 402 may contain a verification key generator 404 and a signing key generator 406. The verification key generator 404 and signing key generator 406 may connect to a public key combiner 408, which may process the generated keys. The key generation module 402 may also connect to a user secret key generator 410 that may produce keys for users of the encryption system 400.

The encryption system 400 may include a broadcast authority 414 that may interact with the obfuscation module 412. In some implementations, the obfuscation module 412 may process data before transmission through the broadcast channel 418. The broadcast channel 418 may connect to broadcast users 416 who may receive the transmitted information.

The components of the encryption system 400 may be arranged in a flow where the key generation module 402 may feed into both the public key combiner 408 and user secret key generator 410. The obfuscation module 412 may receive input from both the public key combiner 408 and the broadcast authority 414 before transmitting through the broadcast channel 418 to the broadcast users 416.

In some cases, the encryption system 400 may implement a structure where generated keys and data may undergo processing through multiple stages before reaching the broadcast users 416. This arrangement may allow for key generation, combination, and obfuscation before broadcast transmission.

The verification key generator 404 may generate verification keys, which may be used to verify the authenticity of messages or users in the encryption system 400. The signing key generator 406 may produce signing keys, which may be used to create digital signatures for messages or data.

In some implementations, the public key combiner 408 may combine multiple verification keys into a single public key. This combined public key may be used for encryption or verification purposes within the encryption system 400.

The user secret key generator 410 may create unique secret keys for individual broadcast users 416. These secret keys may be used by the broadcast users 416 to decrypt messages or authenticate themselves within the encryption system 400.

The broadcast authority 414 may manage the overall operation of the encryption system 400, including determining which users may receive broadcasts and what content may be transmitted. In some cases, the broadcast authority 414 may provide input to the obfuscation module 412 to specify how data should be obfuscated before transmission.

The obfuscation module 412 may apply various techniques to obscure or protect the data being transmitted. This obfuscation process may enhance the security of the encryption system 400 by making it more difficult for unauthorized parties to intercept or understand the transmitted information.

In some implementations, the broadcast channel 418 may be a communication medium through which encrypted and obfuscated data may be transmitted from the encryption system 400 to the broadcast users 416. This channel may be a wireless network, a wired network, or any other suitable means of data transmission.

The broadcast users 416 may be the intended recipients of the encrypted and obfuscated transmissions. These users may have the necessary secret keys and decryption capabilities to access the content transmitted through the broadcast channel 418.

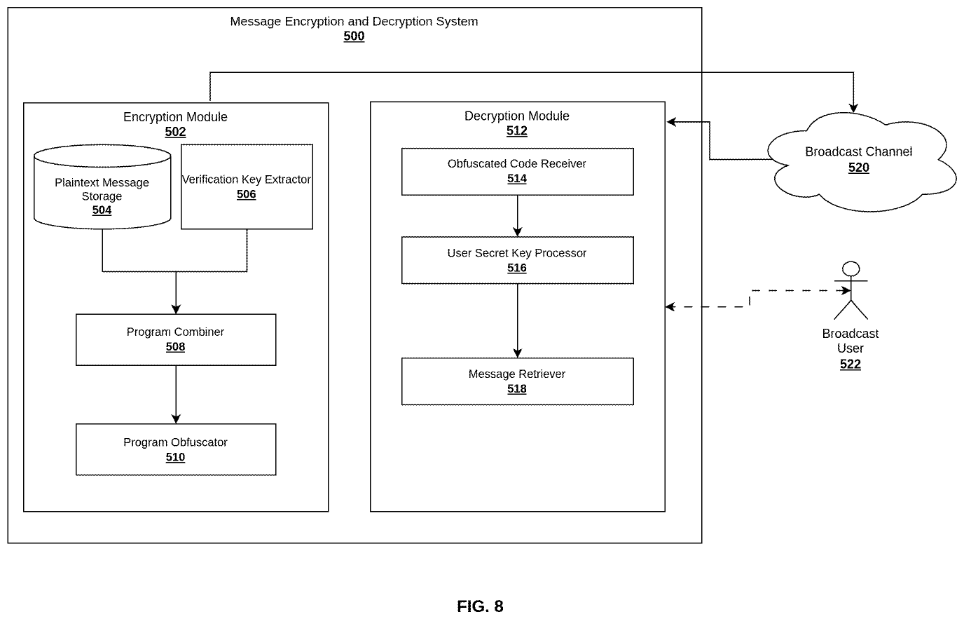

FIG. 8 illustrates a message encryption system 500 for secure broadcast communication. The message encryption system 500 may include an encryption module 502 and a decryption module 512 that communicate through a broadcast channel 520.

In some cases, the encryption module 502 may include a plaintext storage 504 for storing messages to be encrypted. A verification extractor 506 may process verification information, while a program combiner 508 may combine inputs from both the plaintext storage 504 and the verification extractor 506. The program combiner 508 may connect to a program obfuscator 510, which may process the combined program before transmission.

The decryption module 512 may contain a code receiver 514 that receives data from the broadcast channel 520. The code receiver 514 may connect to a key processor 516, which may process the received code using secret keys. A message retriever 518 may obtain the decrypted message based on the processed information from the key processor 516.

In some implementations, the broadcast channel 520 may serve as the communication medium between the encryption module 502 and the decryption module 512. A broadcast user 522 may interact with the message encryption system 500 through the broadcast channel 520, receiving the transmitted messages after processing by the decryption module 512.

The message encryption system 500 may implement a flow where plaintext messages are processed through encryption, transmitted via the broadcast channel 520, and then decrypted for access by the broadcast user 522. This approach may provide secure communication in a broadcast setting.

In some cases, the encryption process may involve the following steps:
1. The plaintext storage 504 may store a message m to be encrypted.
2. The verification extractor 506 may extract a verification key vk₁ from a public key pk.
3. The program combiner 508 may combine the message m and verification key vk₁ into a program E.
4. The program obfuscator 510 may obfuscate the program E to create an obfuscated code F.

The decryption process may involve the following steps:
1. The code receiver 514 may receive the obfuscated code F from the broadcast channel 520.
2. The key processor 516 may process F using a user secret key usk_{id}.
3. The message retriever 518 may obtain the original message m after successful decryption.

This system may provide a secure method for broadcasting encrypted messages to multiple users while ensuring that only authorized users with the appropriate secret keys can decrypt and access the original message.

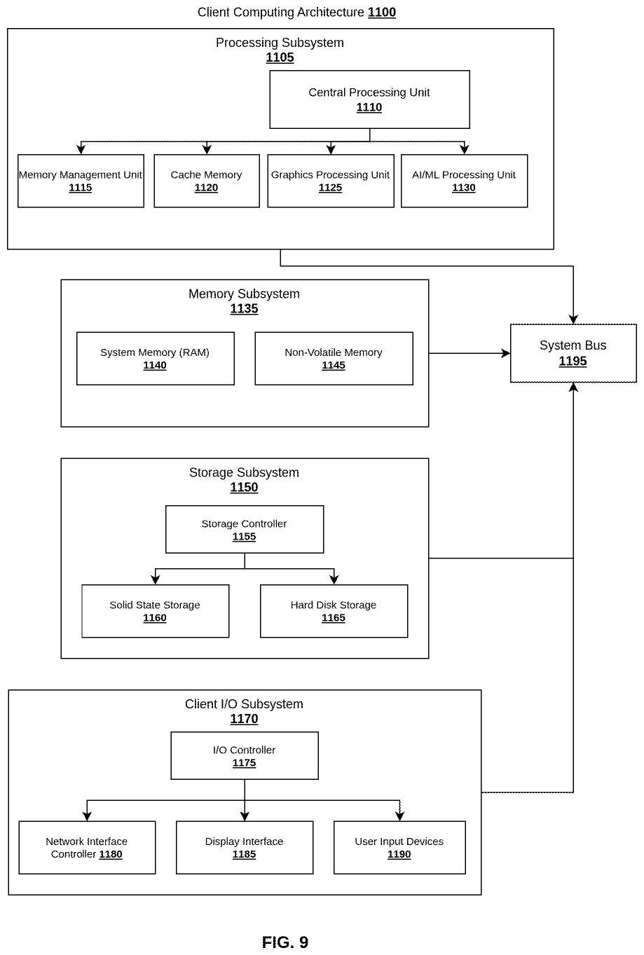

FIG. 9 illustrates a client computing architecture 1100. The client computing architecture 1100 may include multiple subsystems interconnected through a system bus 1195.

In some cases, the client computing architecture 1100 may include a processing subsystem 1105. The processing subsystem 1105 may include a central processing unit 1110. The central processing unit 1110 may connect to several components, including a memory management unit 1115, cache memory 1120, a graphics processing unit 1125, and an AI/ML processing unit 1130.

The client computing architecture 1100 may also include a memory subsystem 1135. The memory subsystem 1135 may contain two types of memory: system memory (RAM) 1140 and non-volatile memory 1145. Both the system memory (RAM) 1140 and the non-volatile memory 1145 may connect to the system bus 1195.

In some implementations, the client computing architecture 1100 may incorporate a storage subsystem 1150. The storage subsystem 1150 may include a storage controller 1155 that manages two storage devices: solid state storage 1160 and hard disk storage 1165. The storage subsystem 1150 may connect to the system bus 1195.

The client computing architecture 1100 may further comprise a client I/O subsystem 1170. The client I/O subsystem 1170 may contain an I/O controller 1175 that manages several components: a network interface controller 1180, a display interface 1185, and user input devices 1190. The client I/O subsystem 1170 may connect to the system bus 1195.

The system bus 1195 may provide communication pathways between the processing subsystem 1105, memory subsystem 1135, storage subsystem 1150, and client I/O subsystem 1170. This arrangement may allow data transfer between these components.

In some cases, the central processing unit 1110 in the processing subsystem 1105 may execute instructions stored in the system memory (RAM) 1140 or non-volatile memory 1145. The memory management unit 1115 may manage the allocation and deallocation of memory addresses, while the cache memory 1120 may store frequently accessed data for quick retrieval by the central processing unit 1110.

The graphics processing unit 1125 may handle rendering of visual content for display through the display interface 1185. In some implementations, the AI/ML processing unit 1130 may perform specialized computations for artificial intelligence and machine learning tasks.

The storage controller 1155 in the storage subsystem 1150 may manage data read and write operations to the solid state storage 1160 and hard disk storage 1165. This may provide the client computing architecture 1100 with both high-speed storage (solid state storage 1160) and high-capacity storage (hard disk storage 1165) options.

The network interface controller 1180 in the client I/O subsystem 1170 may facilitate communication between the client computing architecture 1100 and external networks or devices. The display interface 1185 may manage the output of visual information to a display device, while the user input devices 1190 may allow for user interaction with the client computing architecture 1100.

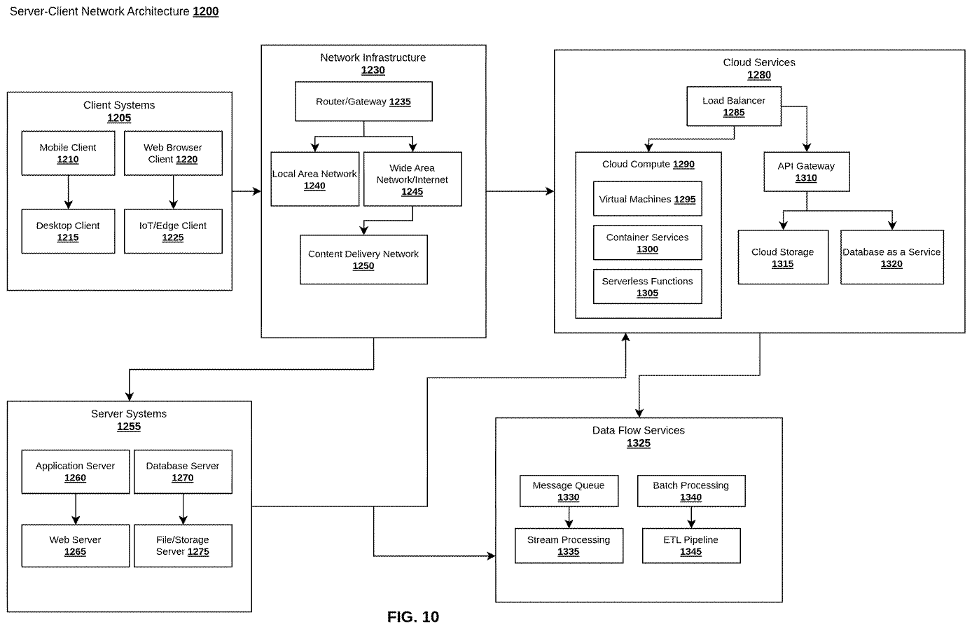

FIG. 10 illustrates a server-client network architecture 1200 that may provide a comprehensive overview of various network components and their interactions. The server-client network architecture 1200 may be divided into four main sections: Client Systems 1205, Network Infrastructure 1230, Server Systems 1255, and Cloud Services 1280.

In some cases, the Client Systems 1205 may include a mobile client 1210, a desktop client 1215, a web browser client 1220, and an IoT/edge client 1225. The mobile client 1210 may connect to the desktop client 1215, while the web browser client 1220 may connect to the IoT/edge client 1225. These client systems may represent different types of devices or applications that users may interact with to access network resources.

The Network Infrastructure 1230 may comprise a router/gateway 1235 that may connect to both a local area network 1240 and a wide area network/internet 1245. In some implementations, a content delivery network 1250 may link to the wide area network/internet 1245. This infrastructure may facilitate communication between client systems and server systems, as well as provide access to cloud services.

The Server Systems 1255 section may include an application server 1260 and a database server 1270. The application server 1260 may connect to a web server 1265, while the database server 1270 may connect to a file/storage server 1275. These server systems may host various applications, manage data storage, and serve web content to client systems.

The Cloud Services 1280 section may encompass multiple components that work together to provide scalable and flexible computing resources. A load balancer 1285 may connect to cloud compute 1290 and an API gateway 1310. The cloud compute 1290 may include virtual machines 1295, container services 1300, and serverless functions 1305. These components may allow for efficient allocation and management of computing resources based on demand.

The API gateway 1310 may connect to cloud storage 1315 and database as a service 1320, providing a centralized point of access for various cloud-based services. This architecture may enable efficient data management and storage in the cloud environment.

In some implementations, the server-client network architecture 1200 may also include data flow services 1325. These services may comprise a message queue 1330 and stream processing 1335 components, alongside batch processing 1340 and ETL pipeline 1345 elements. These data flow services may facilitate efficient data processing, transformation, and movement within the network architecture.

The server-client network architecture 1200 may demonstrate connections between onpremises infrastructure and cloud services, with data potentially flowing between client systems, servers, and cloud components through the network infrastructure. This comprehensive architecture may provide a flexible and scalable framework for modern network applications and services. Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multi-core and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrarylength plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage (NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and non-volatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for high-dimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.nyu

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A stateful broadcast encryption key management method implemented by one or more processors executing instructions stored in a non-transitory computer-readable medium, the method comprising:
(a) establishing a signature scheme with collision resistance properties;
(b) transmitting initial keys to broadcast users by:
(i) generating verification keys vk₀ and vk₁ and corresponding signing keys sk₀ and sk₁ using a secure key generation algorithm;
(ii) combining vk₀ and vk₁ into a public key pk using a deterministic combination function;
(iii) broadcasting pk to the broadcast users over a secure communication channel;
(iv) for each broadcast user with identity id:
(1) combining id into a string s_{id} using a predetermined formatting protocol;
(2) signing s_{id} using either sk₀ or sk₁ to obtain a signature σ_{id}, wherein sk₀ is used for unauthorized users and sk₁ is used for authorized users;
(3) combining s_{id} and σ_{id} into a user secret key usk_{id} using a secure key derivation function;
(4) transmitting usk_{id} to the broadcast user through an encrypted communication channel;
(c) at a start of an epoch:
(i) receiving lists L_{add} and Lᵣₑₘₒᵥₑ of user identities to be added to or removed from the authorized user set, wherein L_{add} contains identities of users who should be granted access to broadcast messages and Lᵣₑₘₒᵥₑ contains identities of users whose access should be revoked;
(ii) generating new verification keys
$${vk}_{0}^{′} and {vk}_{1}^{′}$$
and signing keys
$${sk}_{0}^{′} and {s k}_{1}^{′}$$
using a cryptographically secure random number generator;
(iii) combining
$${vk}_{0}^{′} and {vk}_{1}^{′}$$
into a new public key pk′ using the deterministic combination function;
(iv) combining vk₀, vk₁,
$${sk}_{0}^{′} , {s k}_{1}^{′} ,$$
L_{add}, alle Lᵣₑₘₒᵥₑ into a program P that computes a new user secret key
$${u s k}_{id}^{′}$$
from usk_{id}, wherein P implements a stateful transformation that maintains forward secrecy;
(v) obfuscating P to obtain an obfuscated code Q using techniques that preserve the functionality of P while hiding its implementation details;
(vi) replacing pk with pk′ in a secure storage medium;
(vii) broadcasting pk′ and Q to the broadcast users through a broadcast channel with error detection and correction capabilities;
(viii) verifying the integrity of the broadcast using cryptographic hash functions to ensure the broadcast has not been tampered with during transmission.

2. The method of claim 1, further comprising generating updated keys by:
(i) at each broadcast user, replacing pk with pk′;
(ii) at each broadcast user with id and usk_{id}, running Q on usk_{id} to get
$${usk}_{id}^{′} ;$$
(iii) at each broadcast user with id, replacing usk_{id} with
$${usk}_{id}^{′} .$$

3. The method of claim 1, further comprising encrypting a message by:
(a) storing a plaintext message m at one of the broadcast users;
(b) extracting vk₁ from the public key pk;
(c) combining m and vk₁ into the code of a program E which takes as input a user secret key usk_{id} and:
(i) extracts s_{id} and σ_{id} from usk_{id};
(ii) runs the signature verification algorithm using verification key vk₁, string s_{id}, and signature σ_{id} to obtain a bit b;
(iii) if b equals 1, outputs the message m;
(d) obfuscating the program code E to obtain obfuscated code F;
(e) transmitting the obfuscated code F as the encrypted message to the other broadcast users.

4. The method of claim 3, further comprising decrypting the encrypted message by:
(a) receiving the encrypted message at at least one of the broadcast users with user secret key usk_{id}, wherein the encrypted message comprises the obfuscated code F;
(b) running the obfuscated code F on usk_{id} to obtain the message m.

5. The method of claim 1, wherein the signature scheme is a constrained signature scheme where:
(a) there is a constrained key generation algorithm which:
(i) takes as input a signing key and a constraining program C;
(ii) produces a constrained verification key vk_{C} and constrained signing key sk_{C};
(b) for any string s such that evaluating C on s gives 1, running the signing algorithm on signing key sk_{C} and string s to get signature σ, and then running the signature verification algorithm on vk_{C}, s, and σ will result in output 1;
(c) for constrained verification keys vk_{C} and any string s such that C evaluated on s equals 0, running the signature verification algorithm on vk_{C}, s, and any possible signature will always result in output 0;
(d) constrained verification keys vk_{C} and unconstrained verification keys vk are computationally indistinguishable, even given sk_{C}.

6. The method of claim 1, further comprising executing a tracing routine, the tracing routine comprising:
(a) receiving the public key pk, a pirate decoder D, and data about D;
(b) extracting vk₁ from pk;
(c) executing the following loop for k times, where k is determined by the data about D:
(i) based on the outcomes of the previous iterations of the loop, determining a threshold t;
(ii) combining the data about D, vk₁, and t into the code of a program E which takes as input a user secret key usk_{id} and:
(1) extracts s_{id} and σ_{id} from usk_{id};
(2) extracts id from s_{id};
(3) if id is greater than the threshold t, immediately aborts;
(4) runs the signature verification algorithm using verification key vk₁, string s_{id}, and signature σ_{id} to obtain a bit b;
(5) if b equals 1, outputs a predetermined message m;
(iii) obfuscating the program code E to obtain obfuscated code F;
(iv) running the pirate decoder D on F, and observing the output of D;
(d) based on the observed outputs of D from each of the k iterations of the loop above, accusing one or more of the broadcast users of leaking the pirate decoder D.

7. A stateful broadcast encryption key management system comprising:
(a) one or more processors;
(b) a non-transitory computer-readable medium storing instructions that, when executed by the one or more processors, cause the system to perform operations comprising:
(i) establishing a signature scheme with collision resistance properties;
(ii) transmitting initial keys to broadcast users by:
(1) generating verification keys vk₀ and vk₁ and corresponding signing keys sk₀ and sk₁ using a secure key generation algorithm;
(2) combining vk₀ and vk₁ into a public key pk using a deterministic combination function;
(3) broadcasting pk to the broadcast users over a secure communication channel;
(4) for each broadcast user with identity id:
(i) combining id into a string s_{id} using a predetermined formatting protocol;
(ii) signing s_{id} using either sk₀ or sk₁ to obtain a signature gid, wherein sk₀ is used for unauthorized users and sk₁ is used for authorized users;
(iii) combining s_{id} and σ_{id} into a user secret key usk_{id} using a secure key derivation function;
(iv) transmitting usk_{id} to the broadcast user through an encrypted communication channel;
(iii) at a start of an epoch:
(1) receiving lists L_{add} and Lᵣₑₘₒᵥₑ of user identities to be added to or removed from the authorized user set, wherein L_{add} contains identities of users who should be granted access to broadcast messages and Lᵣₑₘₒᵥₑ contains identities of users whose access should be revoked;
(2) generating new verification keys
$${vk}_{0}^{′}$$
$$and$$
$${vk}_{1}^{′}$$
and signing keys
$${sk}_{0}^{′}$$
$$and$$
$${sk}_{1}^{′}$$
using a cryptographically secure random number generator;
(3) combining
$${vk}_{0}^{′}$$
$$and$$
$${vk}_{1}^{′}$$
into a new public key pk′ using the deterministic combination function;
(4) combining vk₀, vk₁,
$${sk}_{0}^{′} , {sk}_{1}^{′} ,$$
L_{add}, and Lᵣₑₘₒᵥₑ into a program P that computes a new user secret key
$${usk}_{id}^{′}$$
from usk_{id}, wherein i hinpiements a stateful transformation that maintains forward secrecy;
(5) obfuscating P to obtain an obfuscated code Q using techniques that preserve the functionality of P while hiding its implementation details;
(6) replacing pk with pk′ in a secure storage medium;
(7) broadcasting pk′ and Q to the broadcast users through a broadcast channel with error detection and correction capabilities;
(8) verifying the integrity of the broadcast using cryptographic hash functions to ensure the broadcast has not been tampered with during transmission.

8. The system of claim 7, wherein the operations further comprise generating updated keys by:
(i) at each broadcast user, replacing pk with pk′;
(ii) at each broadcast user with id and usk_{id}, running Q on usk_{id} to get
$${usk}_{id}^{′} ;$$
(iii) at each broadcast user with id, replacing usk_{id} with
$${usk}_{id}^{′} .$$

9. The system of claim 7, wherein the operations further comprise encrypting a message by:
(a) storing a plaintext message m at one of the broadcast users;
(b) extracting vk₁ from the public key pk;
(c) combining m and vk₁ into the code of a program E which takes as input a user secret key usk_{id} and:
(i) extracts s_{id} and σ_{id} from usk_{id};
(ii) runs the signature verification algorithm using verification key vk₁, string s_{id}, and signature σ_{id} to obtain a bit b;
(iii) if b equals 1, outputs the message m;
(d) obfuscating the program code E to obtain obfuscated code F;
(e) transmitting the obfuscated code F as the encrypted message to the other broadcast users.

10. The system of claim 9, wherein the operations further comprise decrypting the encrypted message by:
(a) receiving the encrypted message at at least one of the broadcast users with user secret key usk_{id}, wherein the encrypted message comprises the obfuscated code F;
(b) running the obfuscated code F on usk_{id} to obtain the message m.

11. The system of claim 7, wherein the signature scheme is a constrained signature scheme where:
(a) there is a constrained key generation algorithm which:
(i) takes as input a signing key and a constraining program C;
(ii) produces a constrained verification key vk_{C} and constrained signing key sk_{C};
(b) for any string s such that evaluating C on s gives 1, running the signing algorithm on signing key sk_{C} and string s to get signature σ, and then running the signature verification algorithm on vk_{C}, s, and σ will result in output 1;
(c) for constrained verification keys vk_{C} and any string s such that C evaluated on s equals 0, running the signature verification algorithm on vk_{C}, s, and any possible signature will always result in output 0;
(d) constrained verification keys vk_{C} and unconstrained verification keys vk are computationally indistinguishable, even given sk_{C}.

12. The system of claim 7, wherein the operations further comprise executing a tracing routine, the tracing routine comprising:
(a) receiving the public key pk, a pirate decoder D, and data about D;
(b) extracting vk₁ from pk;
(c) executing the following loop for k times, where k is determined by the data about D:
(i) based on the outcomes of the previous iterations of the loop, determining a threshold t;
(ii) combining the data about D, vk₁, and t into the code of a program E which takes as input a user secret key usk_{id} and:
(1) extracts s_{id} and σ_{id} from usk_{id};
(2) extracts id from s_{id};
(3) if id is greater than the threshold t, immediately aborts;
(4) runs the signature verification algorithm using verification key vk₁, string s_{id}, and signature σ_{id} to obtain a bit b;
(5) if b equals 1, outputs a predetermined message m;
(iii) obfuscating the program code E to obtain obfuscated code F;
(iv) running the pirate decoder D on F, and observing the output of D;
(d) based on the observed outputs of D from each of the k iterations of the loop above, accusing one or more of the broadcast users of leaking the pirate decoder D.

13. A non-transitory computer-readable medium storing instructions that, when executed by one or more processors, cause the one or more processors to perform a stateful broadcast encryption key management method comprising:
(a) establishing a signature scheme with collision resistance properties;
(b) transmitting initial keys to broadcast users by:
(i) generating verification keys vk₀ and vk₁ and corresponding signing keys sk₀ and sk₁ using a secure key generation algorithm;
(ii) combining vk₀ and vk₁ into a public key pk using a deterministic combination function;
(iii) broadcasting pk to the broadcast users over a secure communication channel;
(iv) for each broadcast user with identity id:
(1) combining id into a string s_{id} using a predetermined formatting protocol;
(2) signing s_{id} using either sk₀ or sk₁ to obtain a signature σ_{id}, wherein sk₀ is used for unauthorized users and sk₁ is used for authorized users;
(3) combining s_{id} and σ_{id} into a user secret key usk_{id} using a secure key derivation function;
(4) transmitting usk_{id} to the broadcast user through an encrypted communication channel;
(c) at a start of an epoch:
(i) receiving lists L_{add} and Lᵣₑₘₒᵥₑ of user identities to be added to or removed from the authorized user set, wherein L_{add} contains identities of users who should be granted access to broadcast messages and Lᵣₑₘₒᵥₑ contains identities of users whose access should be revoked;
(ii) generating new verification keys
$${vk}_{0}^{′}$$
$$and$$
$${vk}_{1}^{′}$$
and signing keys
$${sk}_{0}^{′}$$
$$and$$
$${sk}_{1}^{′}$$
using a cryptographically secure random number generator;
(iii) combining
$${vk}_{0}^{′}$$
$$and$$
$${vk}_{1}^{′}$$
into a new public key pk′ using the deterministic combination function;
(iv) combining vk₀, vk₁,
$${sk}_{0}^{′} , {sk}_{1}^{′} ,$$
L_{add}, and Lᵣₑₘₒᵥₑ into a program P that computes a new user secret key usk′_{id} from usk_{id}, wherein P implements a stateful transformation that maintains forward secrecy;
(v) obfuscating P to obtain an obfuscated code Q using techniques that preserve the functionality of P while hiding its implementation details;
(vi) replacing pk with pk′ in a secure storage medium;
(vii) broadcasting pk′ and Q to the broadcast users through a broadcast channel with error detection and correction capabilities;
(viii) verifying the integrity of the broadcast using cryptographic hash functions to ensure the broadcast has not been tampered with during transmission.

14. The non-transitory computer-readable medium of claim 13, wherein the method further comprises generating updated keys by:
(i) at each broadcast user, replacing pk with pk′;
(ii) at each broadcast user with id and usk_{id}, running Q on usk_{id} to get
$${usk}_{id}^{′} ;$$
at each broadcast user with id, replacing usk_{id} with
$${usk}_{id}^{′} .$$

15. The non-transitory computer-readable medium of claim 13, wherein the method further comprises encrypting a message by:
(a) storing a plaintext message m at one of the broadcast users;
(b) extracting vk₁ from the public key pk;
(c) combining m and vk₁ into the code of a program E which takes as input a user secret key usk_{id} and:
(i) extracts s_{id} and σ_{id} from usk_{id};
(ii) runs the signature verification algorithm using verification key vk₁, string s_{id}, and signature σ_{id} to obtain a bit b;
(iii) if b equals 1, outputs the message m;
(d) obfuscating the program code E to obtain obfuscated code F;
(e) transmitting the obfuscated code F as the encrypted message to the other broadcast users.

16. The non-transitory computer-readable medium of claim 15, wherein the method further comprises decrypting the encrypted message by:
(a) receiving the encrypted message at at least one of the broadcast users with user secret key usk_{id}, wherein the encrypted message comprises the obfuscated code F;
(b) running the obfuscated code F on usk_{id} to obtain the message m.

17. The non-transitory computer-readable medium of claim 13, wherein the signature scheme is a constrained signature scheme where:
(a) there is a constrained key generation algorithm which:
(i) takes as input a signing key and a constraining program C;
(ii) produces a constrained verification key vk_{C} and constrained signing key sk_{C};
(b) for any string s such that evaluating C on s gives 1, running the signing algorithm on signing key sk_{C} and string s to get signature σ, and then running the signature verification algorithm on vk_{C}, s, and σ will result in output 1;
(c) for constrained verification keys vk_{C} and any string s such that C evaluated on s equals 0, running the signature verification algorithm on vk_{C}, s, and any possible signature will always result in output 0;
(d) constrained verification keys vk_{C} and unconstrained verification keys vk are computationally indistinguishable, even given sk_{C}.

18. The non-transitory computer-readable medium of claim 13, wherein the method further comprises executing a tracing routine, the tracing routine comprising:
(a) receiving the public key pk, a pirate decoder D, and data about D;
(b) extracting vk₁ from pk;
(c) executing the following loop for k times, where k is determined by the data about D:
(i) based on the outcomes of the previous iterations of the loop, determining a threshold t;
(ii) combining the data about D, vk₁, and t into the code of a program E which takes as input a user secret key usk_{id} and:
(1) extracts s_{id} and σ_{id} from usk_{id};
(2) extracts id from s_{id};
(3) if id is greater than the threshold t, immediately aborts;
(4) runs the signature verification algorithm using verification key vk₁, string s_{id}, and signature σ_{id} to obtain a bit b;
(5) if b equals 1, outputs a predetermined message m;
(iii) obfuscating the program code E to obtain obfuscated code F;
(iv) running the pirate decoder D on F, and observing the output of D;
(d) based on the observed outputs of D from each of the k iterations of the loop above, accusing one or more of the broadcast users of leaking the pirate decoder D.
